(19) United States
(12) Patent Application Publication
(10) Pub. No.: US 2018/0048907 A1
(43) Pub. Date: Feb. 15, 2018

(54) VIDEO CODING TOOLS FOR IN-LOOP SAMPLE PROCESSING

(71) Applicant: QUALCOMM Incorporated, San Diego, CA (US)

(72) Inventors: Dmytro Rusanovskyy, San Diego, CA (US); Done Bugdayci Sansli, Tampere (FI)

(21) Appl. No.: 15/674,035

(22) Filed: Aug. 10, 2017

Related U.S. Application Data
(60) Provisional application No. 62/373,884, filed on Aug. 11, 2016.

(51) Int. Cl. H04N 19/51; H04N 19/94; H04N 19/61; H04N 19/176

(52) U.S. Cl. CPC H04N 19/51; H04N 19/176; H04N 19/94; H04N 19/61

(57) ABSTRACT

A device includes a memory device configured to store video data including a current block, and processing circuitry in communication with the memory. The processing circuitry configured to obtain a parameter value that is based on one or more corresponding parameter values associated with one or more neighbor blocks of the video data stored to the memory device, the one or more neighbor blocks being positioned within a spatio-temporal neighborhood of the current block, the spatio-temporal neighborhood including one or more spatial neighbor blocks that are positioned adjacent to the current block and a temporal neighbor block that is pointed to by a disparity vector (DV) associated with the current block. The processing circuitry is also configured to code the current block of the video data stored to the memory device.

This application claims the benefit of U.S. Provisional Application No. 62/373,884, filed on 11 Aug. 2016, the entire contents of which are hereby incorporated by reference.

### TECHNICAL FIELD

This disclosure relates to video encoding and video decoding.

### BACKGROUND

Digital video capabilities can be incorporated into a wide range of device s, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by ITU-T H.261, ISO/IEC MPEG-1 ITU-T H.262 or ISO/IEC MPEG-2 Visual, MPEG-2, MPEG-4, MPEG-4 Visual, ITU-T H.263, ITU-T H.264/MPEG-4, Part 10, Advanced Video Coding (AVC), ISO/IEC MPEG-4 AVC ITU-T H.265, High Efficiency Video Coding (HEVC), and extensions of any of these standards, such as the Scalable Video Coding (SVC) and/or Multi-View Video Coding (MVC) extensions. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques related to coding (e.g., decoding or encoding) of video data. In some examples, the techniques of this disclosure are directed to the coding of video signals with High Dynamic Range (HDR) and Wide Color Gamut (WCG) representations. The described techniques may be used in the context of advanced video codecs, such as extensions of HEVC or the next generation of video coding standards.

In one example, a device for coding video data includes a memory and processing circuitry in communication with the memory. The memory is configured to store video data including a current block. The processing circuitry is configured to obtain a parameter value that is based on one or more corresponding parameter values associated with one or more neighbor blocks of the video data stored to the memory. The one or more neighbor blocks are positioned within a spatio-temporal neighborhood of the current block. The spatio-temporal neighborhood includes one or more spatial neighbor blocks that are positioned adjacent to the current block and a temporal neighbor block that is pointed to by a disparity vector (DV) associated with the current block. The obtained parameter value is used to modify residual data associated with the current block in a coding process. The processing circuitry is further configured to code the current block of the video data stored to the memory.

In another example, a method of coding a current block of video data includes obtaining a parameter value that is based on one or more corresponding parameter values associated with one or more neighbor blocks of the video data positioned within a spatio-temporal neighborhood of the current block. The spatio-temporal neighborhood includes one or more spatial neighbor blocks that are positioned adjacent to the current block and a temporal neighbor block that is pointed to by a disparity vector (DV) associated with the current block. The obtained parameter value is used to modify residual data associated with the current block in a coding process. The method further includes coding the current block of the video data based on the obtained parameter value.

In another example, an apparatus for coding video includes means for obtaining a parameter value that is based on one or more corresponding parameter values associated with one or more neighbor blocks of the video data positioned within a spatio-temporal neighborhood of a current block of the video data, where the spatio-temporal neighborhood includes one or more spatial neighbor blocks that are positioned adjacent to the current block and a temporal neighbor block that is pointed to by a disparity vector (DV) associated with the current block, and where the obtained parameter value is used to modify residual data associated with the current block in a coding process. The apparatus further includes means for coding the current block of the video data based on the obtained parameter value.

In another example, a non-transitory computer-readable storage medium is encoded with instructions that, when executed, cause processing circuitry of a video coding device to obtain a parameter value that is based on one or more corresponding parameter values associated with one or more neighbor blocks of the video data positioned within a spatio-temporal neighborhood of a current block of the video data, the spatio-temporal neighborhood including one or more spatial neighbor blocks that are positioned adjacent to the current block and a temporal neighbor block that is pointed to by a disparity vector (DV) associated with the current block, where the obtained parameter value is used to modify residual data associated with the current block in a coding process, and to code the current block of the video data based on the obtained parameter value.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system configured to implement techniques of the disclosure.

FIG. 2 is a conceptual drawing illustrating the concepts of high dynamic range data.

FIG. 3 is a conceptual diagram illustrating example color gamuts.

FIG. 4 is a flow diagram illustrating an example of High Dynamic Range (HDR)/Wide Color Gamut (WCG) representation conversion.

FIG. 5 is a flow diagram showing an example HDR/WCG inverse conversion.

FIG. 6 is conceptual diagram illustrating example transfer functions.

FIG. 7 is a block diagram illustrating an example for non-constant luminance.

FIG. 8 is a block diagram illustrating techniques of this disclosure for derivation of quantization parameters or scaling parameters from the spatio-temporal neighborhood of a block being coded currently.

FIG. 9 is a block diagram illustrating an example of a video encoder.

FIG. 10 is a block diagram illustrating an example of a video decoder.

FIG. 11 is a flowchart illustrating an example process by which a video decoder may implement techniques of this disclosure.

FIG. 12 is a flowchart illustrating an example process by which a video decoder may implement techniques of this disclosure.

FIG. 13 is a flowchart illustrating an example process by which a video encoder may implement techniques of this disclosure.

FIG. 14 is a flowchart illustrating an example process by which a video encoder may implement techniques of this disclosure.

### DETAILED DESCRIPTION

This disclosure is related to coding of video signals with High Dynamic Range (HDR) and Wide Color Gamut (WCG) representations. More specifically, the techniques of this disclosure include signaling and operations applied to video data in certain color spaces to enable more efficient compression of HDR and WCG video data. The proposed techniques may improve compression efficiency of hybrid based video coding systems (e.g., HEVC-based video coders) used for coding HDR and WCG video data. The details of one or more examples of the disclosure are set forth in the accompanying drawings and the description below. Other features, objects, and advantages will be apparent from the description, drawings, and claims.

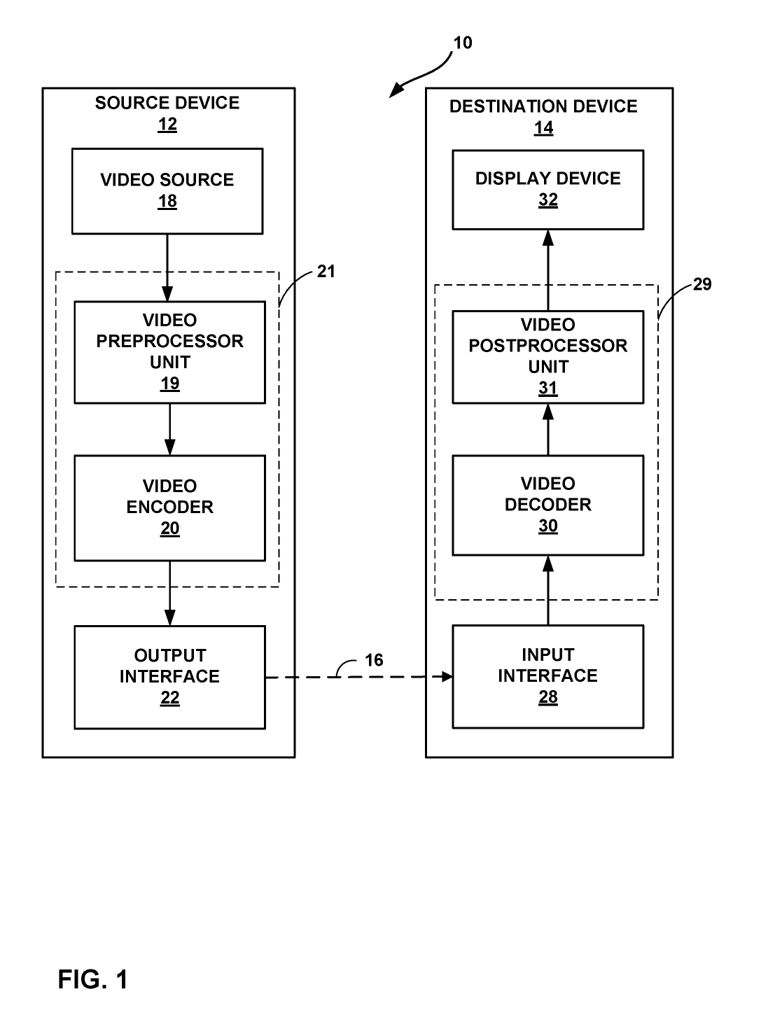

FIG. 1 is a block diagram illustrating an example video encoding and decoding system 10 that may utilize techniques of this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

In the example of FIG. 1, source device 12 includes video source 18, video encoding unit 21, which includes video preprocessor unit 19 and video encoder 20, and output interface 22. Destination device 14 includes input interface 28, video decoding unit 29, which includes video decoder 30 and video postprocessor unit 31, and display device 32. In accordance with some example of this disclosure, video preprocessor unit 19 and video postprocessor unit 31 may be configured to perform all or parts of particular techniques described in this disclosure. For example, video preprocessor unit 19 and video postprocessor unit 31 may include a static transfer function unit configured to apply a static transfer function, but with pre- and post-processing units that can adapt signal characteristics.

In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for processing video data may be performed by any digital video encoding and/or decoding device. Although generally the techniques of this disclosure are performed by a video encoding device, the techniques may also be performed by a video encoder/decoder, typically referred to as a “CODEC.” For ease of description, the disclosure is described with respect to video preprocessor unit 19 and video postprocessor unit 31 performing the example techniques described in this disclosure in respective ones of source device 12 and destination device 14. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video data from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. Source device 12 may comprise one or more data storage media configured to store the video data. As mentioned above, however, the techniques described in this disclosure may be applicable to video coding in general, and may be applied to wireless and/or wired applications. In each case, the captured, pre-captured, or computer-generated video may be encoded by video encoding unit 21. The encoded video information may then be output by output interface 22 onto a computer-readable medium 16.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14. Destination device 14 may comprise one or more data storage media configured to store encoded video data and decoded video data.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20 of video encoding unit 21, which is also used by video decoder 30 of video decoding unit 29, that includes syntax elements that describe characteristics and/or processing of blocks and other coded units, e.g., groups of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

As illustrated, video preprocessor unit 19 receives the video data from video source 18. Video preprocessor unit 19 may be configured to process the video data to convert the video data into a form that is suitable for encoding with video encoder 20. For example, video preprocessor unit 19 may perform dynamic range compacting (e.g., using a non-linear transfer function), color conversion to a more compact or robust color space, and/or floating-to-integer representation conversion. Video encoder 20 may perform video encoding on the video data outputted by video preprocessor unit 19. Video decoder 30 may perform the inverse of video encoder 20 to decode video data, and video postprocessor unit 31 may perform the inverse of the operations performed by video preprocessor unit 19 to convert the video data into a form suitable for display. For instance, video postprocessor unit 31 may perform integer-to-floating conversion, color conversion from the compact or robust color space, and/or inverse of the dynamic range compacting to generate video data suitable for display.

Video encoding unit 21 and video decoding unit 29 each may be implemented as any of a variety of suitable processing circuitry, including fixed function processing circuitry and/or programmable processing circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoding unit 21 and video decoding unit 29 may be included in one or more encoders or decoders, either of which may be integrated as part of a combined encoder/decoder (CODEC) in a respective device.

Although video preprocessor unit 19 and video encoder 20 are illustrated as being separate units within video encoding unit 21 and video postprocessor unit 31 and video decoder 30 are illustrated as being separate units within video decoding unit 29, the techniques described in this disclosure are not so limited. Video preprocessor unit 19 and video encoder 20 may be formed as a common device (e.g., integrated circuit or housed within the same chip). Similarly, video postprocessor unit 31 and video decoder 30 may be formed as a common device (e.g., integrated circuit or housed within the same chip).

In some examples, video encoder 20 and video decoder 30 may operate according to the High Efficiency Video Coding (HEVC) standard developed by the Joint Collaboration Team on Video Coding (JCT-VC) of ITU-T Video Coding Experts Group (VCEG) and ISO/IEC Motion Picture Experts Group (MPEG). A draft of the HEVC standard, referred to as the “HEVC draft specification” is described in Bross et al., “High Efficiency Video Coding (HEVC) Defect Report 3,” Joint Collaborative Team on Video Coding (JCT-VC) of ITU-T SG16 WP3 and ISO/IEC JTC1/SC29/WG11, 16^{th} Meeting, San Jose, US, January 2014, document no. JCTVC-P1003_v1. The HEVC draft specification is available from http://phenix.it-sudparis.eu/jct/doc_end_user/documents/16_San %20Jose/wg11/JCTVC-P1003-v1.zip. The HEVC specification can also be accessed at http://www.itu.int/rec/T-REC-H.265-201504-I/en.

Furthermore, there are ongoing efforts to produce a scalable video coding extension for HEVC. The scalable video coding extension of HEVC may be referred to as SHEVC or SHVC. Additionally, a Joint Collaboration Team on 3D Video Coding (JCT-3C) of VCEG and MPEG is developing a 3DV standard based on HEVC. Part of the standardization efforts for the 3DV standard based on HEVC includes the standardization of a multi-view video codec based on HEVC (i.e., MV-HEVC).

In HEVC and other video coding specifications, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may comprise a coding tree block of luma samples, two corresponding coding tree blocks of chroma samples, and syntax structures used to code the samples of the coding tree blocks. In monochrome pictures or pictures having three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

This disclosure may use the term “video unit” or “video block” or “block” to refer to one or more sample blocks and syntax structures used to code samples of the one or more blocks of samples. Example types of video units may include CTUs, CUs, PUs, transform units (TUs), macroblocks, macroblock partitions, and so on. In some contexts, discussion of PUs may be interchanged with discussion of macroblocks or macroblock partitions.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may comprise a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may comprise a single coding block and syntax structures used to code the samples of the coding block.

Video encoder 20 may partition a coding block of a CU into one or more prediction blocks. A prediction block is a rectangular (i.e., square or non-square) block of samples on which the same prediction is applied. A prediction unit (PU) of a CU may comprise a prediction block of luma samples, two corresponding prediction blocks of chroma samples, and syntax structures used to predict the prediction blocks. In monochrome pictures or pictures having three separate color planes, a PU may comprise a single prediction block and syntax structures used to predict the prediction block. Video encoder 20 may generate predictive blocks (e.g., luma, Cb, and Cr predictive blocks) for prediction blocks (e.g., luma, Cb, and Cr prediction blocks) of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture that includes the PU.

After video encoder 20 generates predictive blocks (e.g., luma, Cb, and Cr predictive blocks) for one or more PUs of a CU, video encoder 20 may generate one or more residual blocks for the CU. For instance, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the Cb residual block of a CU may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the residual blocks (e.g., the luma, Cb, and Cr residual blocks) of a CU into one or more transform blocks (e.g., luma, Cb, and Cr transform blocks). A transform block is a rectangular (e.g., square or non-square) block of samples on which the same transform is applied. A transform unit (TU) of a CU may comprise a transform block of luma samples, two corresponding transform blocks of chroma samples, and syntax structures used to transform the transform block samples. Thus, each TU of a CU may have a luma transform block, a Cb transform block, and a Cr transform block. The luma transform block of the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 20 may apply one or more transforms to a transform block of a TU to generate a coefficient block for the TU. For instance, video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients.

Video encoder 20 may output a bitstream that includes a sequence of bits that forms a representation of coded pictures and associated data. Thus, the bitstream comprises an encoded representation of video data. The bitstream may comprise a sequence of network abstraction layer (NAL) units. A NAL unit is a syntax structure containing an indication of the type of data in the NAL unit and bytes containing that data in the form of a raw byte sequence payload (RBSP) interspersed as necessary with emulation prevention bits. Each of the NAL units may include a NAL unit header and encapsulates a RBSP. The NAL unit header may include a syntax element indicating a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RB SP includes zero bits.

Video decoder 30 may receive a bitstream generated by video encoder 20. In addition, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 20. For instance, video decoder 30 may use motion vectors of PUs to determine predictive blocks for the PUs of a current CU. In addition, video decoder 30 may inverse quantize coefficient blocks of TUs of the current CU. Video decoder 30 may perform inverse transforms on the coefficient blocks to reconstruct transform blocks of the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

Aspects of HDR/WCG will now be discussed. Next generation video applications are anticipated to operate with video data representing captured scenery with HDR and WCG. Parameters of the utilized dynamic range and color gamut are two independent attributes of video content, and their specification for purposes of digital television and multimedia services are defined by several international standards. For example, Recommendation ITU-R BT. 709-5, “Parameter values for the HDTV standards for production and international programme exchange” (2002) (hereinafter, “ITU-R BT. Rec. 709”) defines parameters for HDTV (high definition television), such as Standard Dynamic Range (SDR) and standard color gamut. On the other hand, ITU-R Rec. 2020 specifies UHDTV (ultra-high definition television) parameters such as HDR and WCG. There are also other standards developing organization (SDOs) documents that specify dynamic range and color gamut attributes in other systems. For example, P3 color gamut is defined in SMPTE-231-2 (Society of Motion Picture and Television Engineers) and some parameters of HDR are defined in SMPTE ST 2084. A brief description of dynamic range and color gamut for video data is provided below.

Aspects of dynamic range will now be discussed. Dynamic range is typically defined as the ratio between the minimum and maximum brightness of the video signal. Dynamic range may also be measured in terms of ‘f-stop’ or “f-stops,” where one f-stop corresponds to a doubling of the signal dynamic range. In MPEG's definition, the HDR content is such content that features brightness variation with more than 16 f-stops. In some terms, levels between 10 and 16 f-stops are considered as intermediate dynamic range, but it is considered HDR in other definitions. At the same time, the human visual system (HVS) is capable of perceiving much a larger (e.g., “broader” or “wider”) dynamic range. However, the HVS includes an adaptation mechanism to narrow a so-called “simultaneous range.”

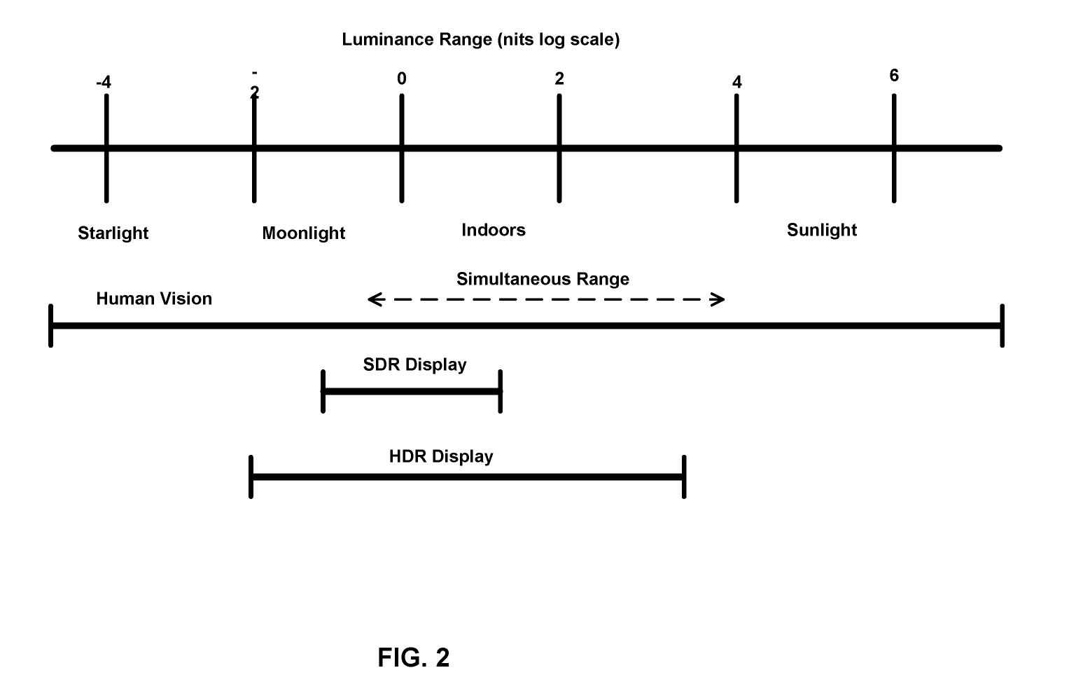

FIG. 2 is a conceptual diagram that illustrates visualization of dynamic range provided by SDR of HDTV, expected HDR of UHDTV and HVS dynamic range. For instance, FIG. 2 illustrates Current video applications and services are regulated by ITU-R BT.709 and provide SDR. Current video applications and services typically support a range of brightness (or luminance) of around 0.1 to 100 candelas (cd) per meter-squared (m̂2) (units of cd/m̂2 are often referred to as “nits”), leading to fewer than or less than 10 f-stops. The next generation video services are expected to provide dynamic ranges of up-to 16 f-stops, and although detailed specifications are currently under development, some initial parameters have been specified in SMPTE ST 2084 and ITU-R BT.2020.

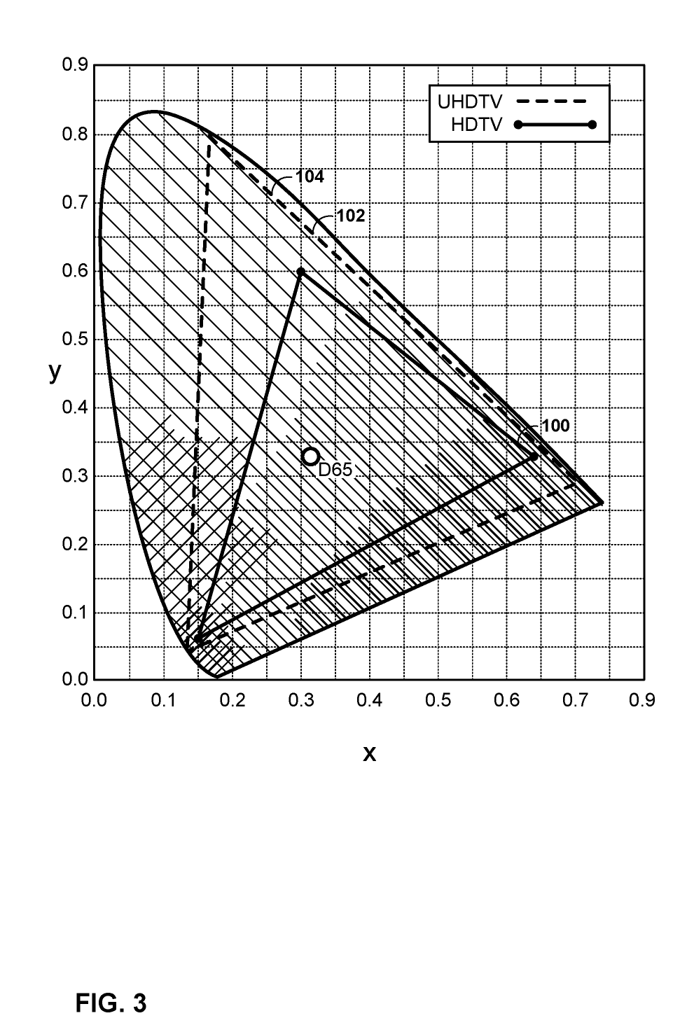

Color gamut will now be discussed. Another aspect for a more realistic video experience besides HDR is the color dimension, which is conventionally defined by the color gamut. FIG. 3 is a conceptual diagram showing an SDR color gamut (triangle based on the ITU-R BT.709 color red, green and blue color primaries), and the wider color gamut for UHDTV (triangle based on the ITU-R BT.2020 color red, green and blue color primaries). FIG. 3 also depicts the so-called spectrum locus (delimited by the tongue-shaped area), representing limits of the natural colors. As illustrated by FIG. 3, moving from ITU-R BT.709 to ITU-R BT.2020 color primaries aims to provide UHDTV services with about 70% more colors or greater colors. D65 specifies the white color for given specifications.

A few examples of color gamut specifications are shown in Table 1, below.

TABLE 1
Color gamut parameters
RGB color space parameters

| | Color space | | | | | | | |
|---|---|---|---|---|---|---|---|---|
| | White point | | Primary colors | | | | | |
| | xx_{W} | yy_{W} | xx_{R} | yy_{R} | xx_{G} | yy_{G} | xx_{B} | yy_{B} |
| DCI-P3 | 0.314 | 0.351 | 0.680 | 0.320 | 0.265 | 0.690 | 0.150 | 0.060 |
| ITU-R | 0.3127 | 0.3290 | 0.64 | 0.33 | 0.30 | 0.60 | 0.15 | 0.06 |
| BT.709 | | | | | | | | |
| ITU-R | 0.3127 | 0.3290 | 0.708 | 0.292 | 0.170 | 0.797 | 0.131 | 0.046 |
| BT.2020 | | | | | | | | |

Aspects of representations of HDR video data will now be discussed. HDR/WCG is typically acquired and stored at a very high precision per component (even floating point), with the 4:4:4 chroma format and a very wide color space (e.g., XYZ). CIE 1931, set forth by the International Commission on Illumination, is an example of the XYZ color space. This representation targets high precision and is (almost) mathematically lossless. However, this format feature may include a lot of redundancies and is not optimal for compression purposes. A lower precision format with HVS-based assumption is typically utilized for state-of-the-art video applications.

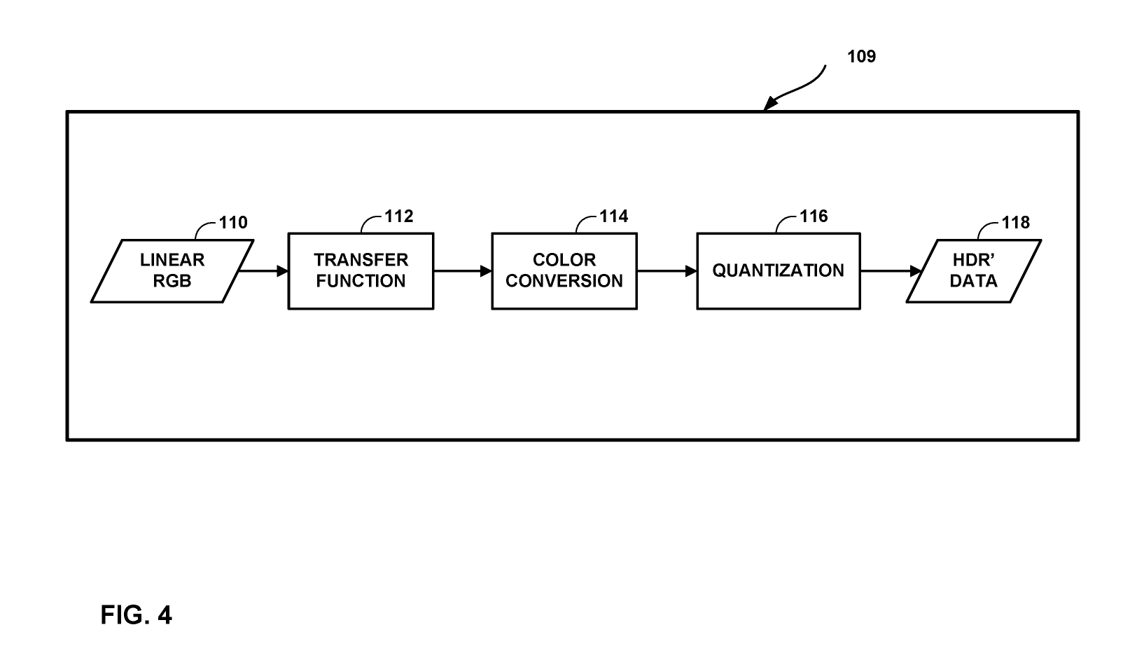

One example of a video data format conversion process for purposes of compression includes three major processes, as shown by conversion process 109 of FIG. 4. The techniques of FIG. 4 may be performed by source device 12. Linear RGB data 110 may be HDR/WCG video data and may be stored in a floating point representation. Linear RGB data 110 may be compacted using a non-linear transfer function (TF) 112 for dynamic range compacting. Transfer function 112 may compact linear RGB data 110 using any number of non-linear transfer functions, e.g., the PQ TF as defined in SMPTE-2084. In some examples, color conversion process 114 converts the compacted data into a more compact or robust color space (e.g., a YUV or YCrCb color space) that is more suitable for compression by a hybrid video encoder. This data is then quantized using a floating-to-integer representation quantization unit 116 to produce converted HDR′ data 118. In this example HDR′ data 118 is in an integer representation. The HDR′ data is now in a format more suitable for compression by a hybrid video encoder (e.g., video encoder 20 applying HEVC techniques). The order of the processes depicted in FIG. 4 is given as an example, and may vary in other applications. For example, color conversion may precede the TF process. In addition, additional processing, e.g. spatial subsampling, may be applied to color components.

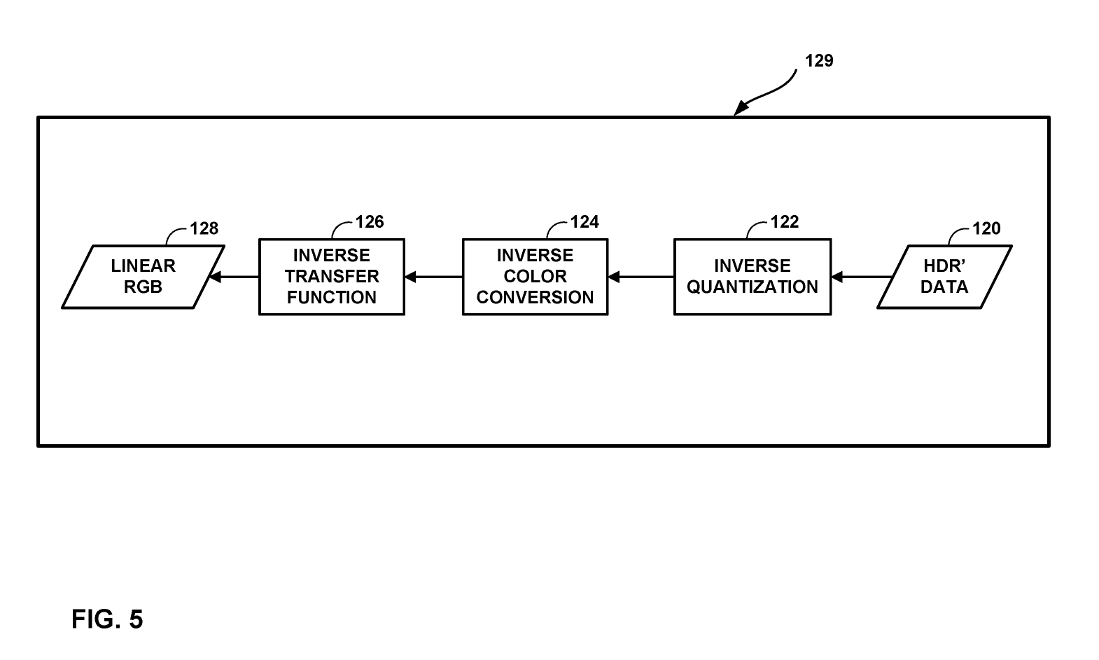

An example inverse conversion at the decoder side is depicted in FIG. 5, by way of process 129. Video postprocessor unit 31 of destination device 14 may perform the techniques of FIG. 5. Converted HDR′ data 120 may be obtained at destination device 14 through decoding video data using a hybrid video decoder (e.g., video decoder 30 applying HEVC techniques). HDR′ data 120 may then be inverse quantized by inverse quantization unit 122. Then an inverse color conversion process 124 may be applied to the inverse quantized HDR′ data. The inverse color conversion process 124 may be the inverse of color conversion process 114. For example, the inverse color conversion process 124 may convert the HDR′ data from a YCrCb format back to an RGB format. Next, inverse transfer function 126 may be applied to the data to add back the dynamic range that was compacted by transfer function 112 to recreate the linear RGB data 128. The high dynamic range of input RGB data in linear and floating point representation is compacted with the utilized non-linear transfer function (TF). For instance, the perceptual quantizer (PQ) TF as defined in SMPTE ST 2084, following which it is converted to a target color space more suitable for compression, e.g. Y′CbCr, and then quantized to achieve integer representation. The order of these elements is given as an example, and may vary in real-world applications, e.g., color conversion may precede the TF module, as well as additional processing, e.g., spatial subsampling may be applied to color components. These three components are described in greater detail below.

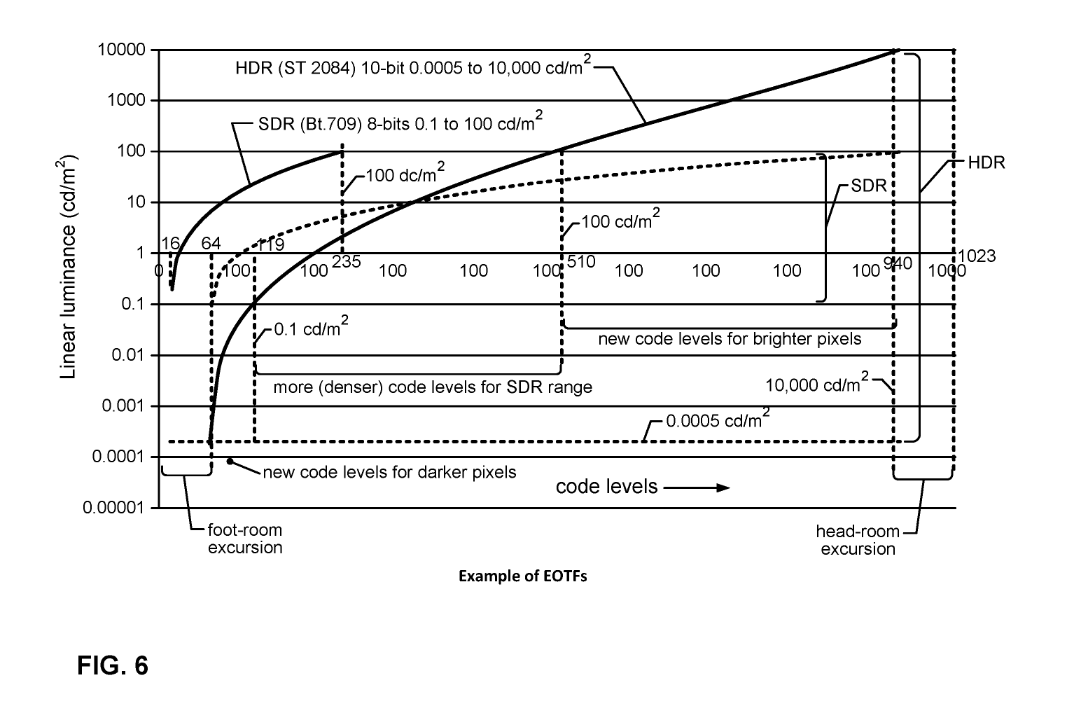

Certain aspects depicted in FIG. 4 will now be discussed in more detail, such as the transfer function (TF). Mapping the digital values appearing in an image container to and from optical energy may require knowledge of the TF. A TF is applied to the data to compact the data's dynamic range and make it possible to represent the data with limited number of bits. This function is typically a one-dimensional (1D) non-linear function either reflecting an inverse of electro-optical transfer function (EOTF) of the end-user display as specified for SDR in ITU-R BT. 1886 and Rec. 709 or approximating the HVS perception to brightness changes as for PQ TF specified in SMPTE ST 2084 for HDR. The inverse process of the OETF is the EOTF (electro-optical transfer function), which maps the code levels back to luminance. FIG. 6 shows several examples of TFs. These mappings may also be applied to each R, G, and B component separately. Applying these mappings to the R, G, and B components may convert them to R′, G′, and B′, respectively.

The reference EOTF specified in ITU-R recommendation BT.1886 is specified by the following equation:

L=a(max[(V+b),0])^{γ}

where:
L: Screen luminance in cd/m̂2
L_{W}: Screen luminance for white
L_{B}: Screen luminance for black
V: Input video signal level (normalized, black at V=0, to white at V=1. For content mastered per Recommendation ITU-R BT.709, 10-bit digital code values “D” map into values of V per the following equation: V=(D-64)/876
γ: Exponent of power function, γ=2.404
a: Variable for user gain (legacy “contrast” control)

a=(L_{W}^{1/γ}−L_{B}^{1/γ})^{γ}
b: Variable for user black level lift (legacy “brightness” control)

$$b = \frac{{L}_{B}^{1 / γ}}{{L}_{W}^{1 / γ} - {L}_{B}^{1 / γ}}$$

Above variables a and b are derived by solving following equations in order that V=1 gives

L=L_{W} and that V=0 gives L=L_{B}:

L_{B}=a·b^{γ}

L_{W}=a·(1+b)^{γ}

In order to support higher dynamic range data more efficiency, SMPTE has recently standardized a new transfer function called SMPTE ST-2084. A specification of ST2084 defined the EOTF application as described as follows. A TF is applied to normalized linear R, G, B values, which results in nonlinear representation of R′, G′, B′. ST2084 defines normalization by NORM=10000, which is associated with a peak brightness of 10000 nits (cd/m̂2).

$$R ’ = PQ\_TF ( max ( 0 , min ( R / NORM , 1 ) ) ) \\ G ’ = PQ\_TF ( max ( 0 , min ( G / NORM , 1 ) ) ) \\ B ’ = PQ\_TF ( max ( 0 , min ( B / NORM , 1 ) ) ) \\ with PQ\_TF ( L ) = {( \frac{{c}_{1} + {c}_{2} {L}^{{m}_{1}}}{1 + {c}_{3} {L}^{{m}_{1}}} )}^{{m}_{2 }} \\ {m}_{1} = \frac{2610}{4096} \times \frac{1}{4} = 0.1593017578125 \\ {m}_{2} = \frac{2523}{4096} \times 128 = 78.84375 \\ {c}_{1} = {c}_{3} - {c}_{2} + 1 = \frac{3424}{4096} = 0.8359375 \\ {c}_{2} = \frac{2413}{4096} \times 32 = 18.8515625 \\ {c}_{3} = \frac{2392}{4096} \times 32 = 18.6875 \qquad ( 1 )$$

Typically, EOTF is defined as a function with a floating point accuracy. Thus, no error is introduced to a signal with this non-linearity if inverse TF (a so-called OETF) is applied. Inverse TF (OETF) as specified in ST2084 is defined using an inverse PQ function as follows:

$$R = 10000 * inversePQ\_TF ( R ’ ) \\ G = 10000 * inversePQ\_TF ( G ’ ) \\ B = 10000 * inversePQ\_TF ( B ’ ) \\ with inversePQ\_TF ( N ) = {( \frac{max [ ( {N}^{1 / {m}_{2}} - {c}_{1} ) , 0 ]}{{c}_{2} - {c}_{3} {N}^{1 / {m}_{2}}} )}^{1 / {m}_{1}} \\ {m}_{1} = \frac{2610}{4096} \times \frac{1}{4} = 0.1593017578125 \\ {m}_{2} = \frac{2523}{4096} \times 128 = 78.84375 \\ {c}_{1} = {c}_{3} - {c}_{2} + 1 = \frac{3424}{4096} = 0.8359375 \\ {c}_{2} = \frac{2413}{4096} \times 32 = 18.8515625 \\ {c}_{3} = \frac{2392}{4096} \times 32 = 18.6875 \qquad ( 2 )$$

EOTF and OETF are subjects of active research and standardization, and a TF utilized in some video coding systems may be different from the TF as specified in ST2084.

Color Transform will now be discussed. RGB data is typically used as input, because RGB data is often produced by image capturing sensors. However, this color space has high redundancy among its components and is not optimal for compact representation. To achieve a more compact and more robust representation, RGB components are typically converted to a more uncorrelated color space (i.e., a color transform is performed) that is more suitable for compression, e.g., YCbCr. This color space separates the brightness in the form of luminance and color information in different un-correlated components.

For modern video coding systems, a commonly-used or typically-used color space is YCbCr, as specified in ITU-R BT.709. The YCbCr color space in the BT.709 standard specifies the following conversion process from R′G′B′ to Y′CbCr (non-constant luminance representation):

$${Y}^{′} = 0.2126 * {R}^{′} + 0.7152 * {G}^{′} + 0.0722 * {B}^{′} \\ Cb = \frac{{B}^{′} - {Y}^{′}}{1.8556} \\ Cr = \frac{{R}^{′} - {Y}^{′}}{1.5748} \qquad ( 3 )$$

The above can also be implemented using the following approximate conversion that avoids the division for the Cb and Cr components:

Y′=0.212600*R′+0.715200*G′+0.072200*B′

Cb=−0.114572*R′−0.385428*G′+0.500000*B′ (4)

Cr=0.500000*R′−0.454153*G′−0.045847*B′

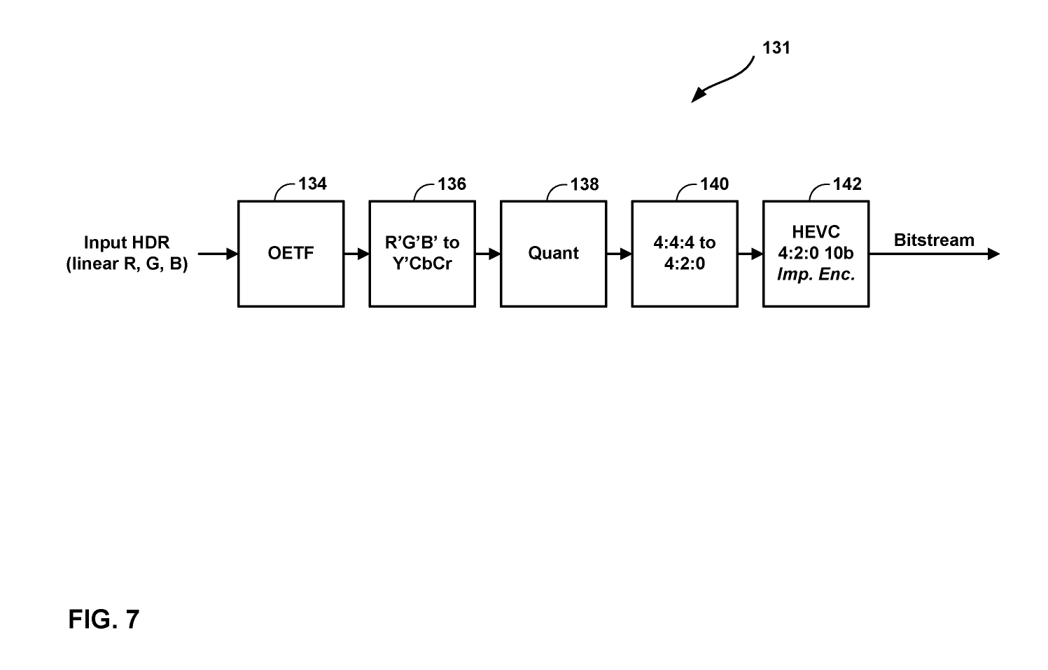

The ITU-R BT.2020 standard specifies two different conversion processes from RGB to Y′CbCr: Constant-luminance (CL) and Non-constant luminance (NCL), Recommendation ITU-R BT. 2020, “Parameter values for ultra-high definition television systems for production and international programme exchange” (2012). The RGB data may be in linear light and Y′CbCr data is non-linear. FIG. 7 is a block diagram illustrating an example for non-constant luminance. Particularly, FIG. 7 shows an example of an NCL approach, by way of process 131. The NCL approach of FIG. 7 applies the conversion from R′G′B′ to Y′CbCr (136) after OETF (134). The ITU-R BT.2020 standard specifies the following conversion process from R′G′B′ to Y′CbCr (non-constant luminance representation):

$${Y}^{′} = 0.2627 * {R}^{′} + 0.6780 * {G}^{′} + 0.0593 * {B}^{′} \\ Cb = \frac{{B}^{′} - {Y}^{′}}{1.8814} \\ Cr = \frac{{R}^{′} - {Y}^{′}}{1.4746} \qquad ( 5 )$$

The above can also be implemented using the following approximate conversion that avoids the division for the Cb and Cr components, as described in the following equation(s):

Y′=0.262700*R′+0.678000*G+0.059300*B′

Cb=−0.139630*R′−0.360370*G′+0.500000*B′ (6)

Cr=0.500000*R′−0.459786*G′−0.040214*B′

Quantization/Fix point conversion will now be discussed. Following the color transform, input data in a target color space still represented at high bit-depth (e.g., floating point accuracy) is converted to a target bit-depth. Certain studies show that ten-to-twelve (10-12) bits accuracy in combination with the PQ TF is sufficient to provide HDR data of 16 f-stops with distortion below the Just-Noticeable Difference (JND). Data represented with 10-bit accuracy can be further coded with most of the state-of-the-art video coding solutions. This quantization (138) is an element of lossy coding and may be a source of inaccuracy introduced to converted data.

In various examples, such quantization may be applied to code words in a target color space. An example in which YCbCr is applied is shown below. Input values YCbCr represented in floating point accuracy are converted into a signal of fixed bit-depth BitDepthY for the luma (Y) value and BitDepthC for the chroma values (Cb, Cr).

D_{Y′}=Clip1_{Y}(Round((1<<(BitDepth_{Y}−8))*(219*Y′+16)))

D_{Cb}=Clip1_{C}(Round((1<<(BitDepth_{C}−8))*(224*Cb+128))) (7)

D_{Cr}=Clip1_{C}(Round((1<<(BitDepth_{C}−8))*(224*Cr+128)))

with
Round(x)=Sign(x)*Floor(Abs(x)+0.5)
Sign(x)=−1 if x<0, 0 if x=0, 1 if x>0
Floor(x) the largest integer less than or equal to x
Abs(x)=x if x>=0, −x if x<0
Clip1_{Y}(x)=Clip3(0, (1<<BitDepth_{Y})−1, x)
Clip1_{C}(x)=Clip3(0, (1<<BitDepth_{C})−1, x)
Clip3(x,y,z)=x if z<x, y if z>y, z otherwise

Some of the transfer functions and color transforms may result in video data representation that features significant variation of a Just-Noticeable Difference (JND) threshold value over the dynamic range of the signal representation. For such representations, a quantization scheme that is uniform over the dynamic range of luma values would introduce quantization error with different merit of perception over the signal fragments (which represent partitions of dynamical range). Such impact on signals may be interpreted as a processing system with a non-uniform quantization which results in unequal signal-to-noise ratios within processed data range. Process 131 of FIG. 7 also includes a conversion from 4:4:4 to 4:2:0 (140) and HEVC 4:2:0 10b encoding (142).

An example of such a representation is a video signal represented in a Non Constant Luminance (NCL) YCbCr color space, for which color primaries are defined in ITU-R Rec. BT.2020 and with an ST 2084 transfer function. As illustrated in Table 2 below, this representation (e.g., the video signal represented in the NCL YCbCr color space) allocates a significantly larger amount of codewords for the low intensity values of the signal. For instance, 30% of the codewords represent linear light samples below ten nits (<10 nits). In contrast, high intensity samples (high brightness) are represented with an appreciably smaller amount of codewords. For instance, 25% of the codewords are allocated for linear light in the range 1000-10,000 nits. As a result, a video coding system, such as an H.265/HEVC video coding system, featuring uniform quantization for all ranges of the data, would introduce much more severe coding artifacts to the high intensity samples (bright region of the signal), whereas the distortion introduced to low intensity samples (dark region of the same signal) would be far below a noticeable difference.

Effectively, the factors described above may mean that video coding system design, or encoding algorithms, may need to be adjusted for every selected video data representation, namely for every selected transfer function and color space. Because of codeword differences, the SDR coding devices may not be optimized for HDR content. Also, a significant amount of video content has been captured in the SDR dynamic range and SCG colors (provided by Rec. 709). As compared to HDR and WCG, the SDR-SCG video capture provides a narrow range. As such, the SDR-SCG captured video data may occupy a relatively small the footprint of a codeword scheme with respect to HDR-WCG video data. To illustrate, the SCG of Rec. 709 covers 35.9% of the CIE 1931 color space, while WCG of the Rec. 2020 covers 75.8%.

TABLE 2
Relation between linear light intensity and
code value in SMPTE ST 2084 (bit depth = 10)

| Linear light intensity (cd/m²) | Full range | SDI range | Narrow range |
|---|---|---|---|
| ~0.01 | 21 | 25 | 83 |
| ~0.1 | 64 | 67 | 119 |
| ~1 | 153 | 156 | 195 |
| ~10 | 307 | 308 | 327 |
| ~100 | 520 | 520 | 509 |
| ~1,000 | 769 | 767 | 723 |
| ~4,000 | 923 | 920 | 855 |
| ~10,000 | 1023 | 1019 | 940 |

As shown in Table 2 above, a high concentration of the codewords (shown in the “full range” column) are concentrated in a low-brightness range. That is, a total 307 codewords (which constitute approximately 30% of the codewords) are clustered within the 0-10 nits range of linear light intensity. In low-brightness scenarios, color information may not be easily perceptible, and may be visible at low levels of visual sensitivity. Because of the concentrated clustering of codewords being positioned in the low-brightness range, a video encoding device may encode a significant amount of, in high quality or very high quality, in the low-brightness range. Moreover, the bitstream may consume greater amounts of bandwidth in order to convey the encoded noise. A video decoding device, when reconstructing the bitstream, may produce a greater number of artifacts, due to the encoded noise being included in the bitstream.

Existing proposals to improve non-optimal perceptual quality codeword distribution are discussed below. One such proposal is “Dynamic Range Adjustment SEI to enable High Dynamic Range video coding with Backward-Compatible Capability,” by D. Rusanovskyy, A. K. Ramasubramonian, D. Bugdayci, S. Lee, J. Sole, M. Karczewicz, VCEG document COM16-C 1027-E, September2015 (hereinafter “Rusanovskyy I”). Rusanovskyy I included a proposal to apply a codewords re-distribution to video data prior to video coding. According to this proposal, video data in the ST 2084/BT.2020 representation undergoes a codeword re-distribution prior to video compression. This proposal introduced re-distribution introduce linearization of perceived distortion (signal to noise ratio) within a dynamical range of the data through a Dynamical Range Adjustment. This redistribution was found to improve visual quality under the bitrate constrains. To compensate the redistribution and convert data to the original ST 2084/BT.2020 representation an inverse process is applied to the data after video decoding. The techniques proposed by Rusanovskyy I are further described further in U.S. patent application Ser. No. 15/099,256 (claiming priority to provisional patent application No. 62/149,446) and U.S. patent application Ser. No. 15/176,034 (claiming priority to provisional patent application No. 62/184,216), the entire content of each of which is incorporated herein in its entirety.

However, according to the techniques described in Rusanovskyy I, the processes of pre- and post-processing are generally de-coupled from rate distortion optimization processing employed by state-of-the-art encoders at the block-based basis. Therefore, the described techniques are from the point of view of pre-processing and post-processing, which are outside of (or external to) the coding loop of a video codec.

Another such proposal is “Performance investigation of high dynamic range and wide color gamut video coding techniques,” by J. Zhao, S.-H. Kim, A. Segall, K. Misra, VCEG document COM16-C 1030-E, September2015 (hereinafter “Zhao I”). Zhao proposed an intensity dependent spatially varying (block based) quantization scheme to align bitrate allocation and visually-perceived distortion between video coding applied on Y2020 (ST2084/BT2020) and Y709 (BT1886/BT 2020) representations. It was observed that to maintain the same level of quantization in luma, the quantization of signal in Y2020 and Y709 must differ by a value that depends on luma, such that:

QP_Y2020=QP_Y709−f(Y2020)

The function f (Y2020) was found to be linear for intensity values (brightness level) of video in Y2020, and it may be approximated as:

f(Y2020)=max(0.03*Y2020−3,0)

Zhao I proposed spatially varying quantization scheme being introduced at the encoding stage was found to be able to improve visually perceived signal-to-quantization noise ratio for coded video signal in ST 2084/BT.2020 representation.

A potential drawback of the techniques proposed in Zhao I is a block-based granularity of QP adaptation. Typically, utilized block sizes selected at the encoder side for compression are derived through a rate distortion optimization process, and may not represent dynamical range properties of the video signal. Thus, the selected QP settings may be sub-optimal for the signal inside of the block. This potential problem may become even more important for the next generation of video coding systems that tend to employ prediction and transform block sizes of larger dimensions. Another aspect of this design is a need for signaling of QP adaptation parameters. QP adaptation parameters are signaled to the decoder for inverse dequantization. Additionally, spatial adaptation of quantization parameters at the encoder side may increase the complexity of encoding optimization and may interfere with rate control algorithms.

Another such proposal is “Intensity dependent spatial quantization with application in HEVC,” by Matteo Naccari and Marta Mrak, In Proc. of IEEE ICME 2013, July 2013 (hereinafter “Naccari”). Naccari proposed an Intensity Dependent Spatial Quantization (IDSQ) perceptual mechanism, which exploits the intensity masking of the human visual system and perceptually adjusts quantization of the signal at the block level. This paper proposed employing in-loop pixel domain scaling. According to this proposal, parameters of in-loop scaling for a currently-processed block are derived from average values of luma component in the predicted block. At the decoder side, the inverse scaling is performed, and the decoder derives parameters of scaling from the predicted block available at the decoder side.

Similarly to the work in Zhao I discussed above, a block-based granularity of this approach restricts the performance of this method due sub-optimality of scaling parameter which is applied to all samples of the processed block. Another aspect of the proposed solution of this paper is that the scale value is derived from predicted block and does not reflect signal fluctuation which may happen between a current codec block and a predicted block.

Another such proposal is “De-quantization and scaling for next generation containers,” by J. Zhao, A. Segall, S.-H. Kim, K. Misra, JVET document B0054, January 2016 (hereinafter Zhao II″). To improve non-uniform perceived distortion in the ST 2084/BT2020 representation, this paper proposed employing in-loop intensity dependent block based transform domain scaling. According to this proposal, parameters of in-loop scaling for selected transform coefficients (AC coefficients) of the currently processed block are derived as a function of average values of a luma component in the predicted block and DC value derived for the current block. At the decoder side, the inverse scaling is performed, and the decoder derives parameters of AC coefficient scaling from predicted block available at the decoder side and from quantized DC value which is signalled to the decoder.

Similarly to works in Zhao I and Naccari discussed above, a block-based granularity of this approach restricts the performance of this method due sub-optimality of scaling parameter which is applied to all samples of the processed block. Another aspect of this paper's proposed scheme is that the scale value is applied to AC transform coefficients only, therefor signal-to-noise ratio improvement does not affect the DC value, which reduces the performance of the scheme. In addition to the aspects discussed above, in some video coding system designs, a quantized DC value may not be available at the time of AC values scaling, such as in a case where the quantization process follows a cascade of transform operations. Another restriction of this proposal is that when the encoder selects the transform skip or transform/quantization bypass modes for the current block, scaling is not applied (hence, at the decoder, scaling is not defined for transform skip and transform/quantization bypass modes) which is sub-optimal due to exclusion of potential coding gain for these two modes.

In U.S. patent application Ser. No. 15/595,793 (claiming priority to provisional patent application No. 62/337,303) by Dmytro Rusanovskyy et al. (hereinafter “Rusanovskyy II”), in-loop sample processing for video signals with non-uniformly distributed Just Noticeable Difference (JND). According to the techniques of Rusanovskyy II, several in-loop coding approaches for more efficient coding of signals with non-uniformly distributed Just Noticeable Difference. Rusanovskyy II describes application of scale and offset of signal samples represented either in pixel, residual or transform domain. Several algorithms for derivation of the scale and offset has been proposed. The content of Rusanovskyy II is incorporated by reference herein in its entirety.

This disclosure discusses several devices, components, apparatuses, and methods for processing that can be applied in the loop of the video coding system. The techniques of this disclosure may include processes of quantization and/or scaling of a video signal in the pixel domain or in a transform domain to improve signal-to-quantization noise ratios for the processed data. For instance, the systems and techniques of this disclosure may reduce artifacts caused by conversion of video data captured in SDR-SCG format when converted to HDR-WCG format. Techniques described herein may address precision using one or both of luminance and/or chrominance data. The disclosed systems and techniques also incorporate or include several algorithms for derivation of quantization or scaling parameters from a spatio-temporal neighborhood of the signal. That is, example systems and techniques of this disclosure are directed to obtaining one or more parameter values that are used to modify residual data associated with the current block in a coding process. As used herein, a parameter value that is used to modify residual data may include a quantization parameter (used to modify the residual data by quantizing or dequantizing residual data in an encoding process or decoding process, respectively), or a scaling parameter (used to modify the residual data by scaling or inverse-scaling residual data in an encoding process or decoding process, respectively).

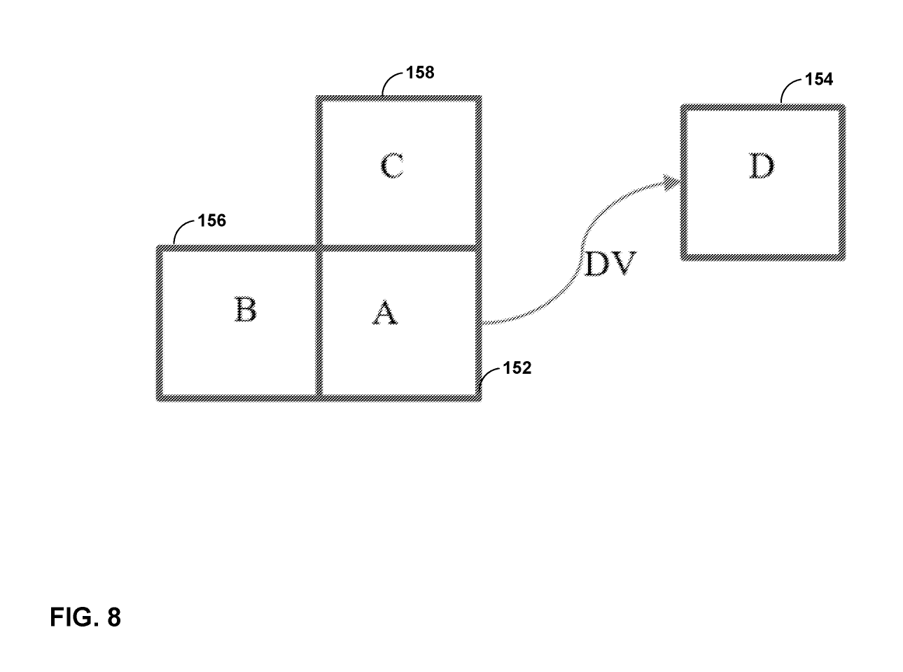

FIG. 8 is a conceptual diagram illustrating aspects of a spatio-temporal neighborhood of a currently-coded block 152. According to one or more techniques of this disclosure, video encoder 20 may derive quantization parameters (to be used in the quantization of samples of currently-coded block 152) using information from the spatio-temporal neighborhood of currently-coded block 152. For instance, video encoder 20 may derive a reference QP or a default QP for use with currently-coded block 152 using QP values used for one or more of neighboring blocks 154, 156, and 158. For example, video encoder 20 may use the QP values for one or more of neighboring blocks 154-158 as criteria or operands in a delta QP derivation process with respect to currently-coded block 152. In this way, video encoder 20 may implement one or more techniques of this disclosure to consider samples of left neighbor block 156, samples of top neighbor block 158, and samples of a temporal neighbor block 154, which is pointed to by a disparity vector “DV.”

As such, video encoder 20 may implement the techniques of this disclosure to expand the delta QP derivation process for currently-coded block 152 to base the delta QP derivation process at least partially on various neighboring blocks of the spatio-temporal neighborhood, if video encoder 20 determines that samples of spatio-temporal neighboring blocks are a good match for the samples of currently-coded block 152. In instances where a block of reference samples overlaps with multiple CUs of the block partitioning, and thus can have different QP, video encoder 20 may derive the QP from a multitude of the available QPs. For instance, video encoder 20 may implement a process of averaging with respect to the multiple QP values, to derive the QP value for the samples of currently-coded block 152. In various examples, video encoder 20 may implement the derivation techniques described above to derive one or both of a QP value and/or delta QP parameters.

In various use-case scenarios, video encoder 20 may also derive scaling parameters for the samples of currently-coded block 152 using information from the spatio-temporal neighborhood of currently-coded block 152. For example, in accordance with designs where a scaling operation replaces uniform quantization, video encoder 20 may apply the spatio-temporal neighborhood-based derivation process described above to derive reference scaling parameters or default scaling parameters for currently-coded block 152.

According to some existing HEVC/JEM techniques, a video coding device may apply scaling operations to all transform coefficients of a currently-processed block. For instance, in some HEVC/JEM designs, a video coding device may apply one or more scaling parameters to a sub-set of transform coefficients, while utilizing the remaining transform coefficients for the derivation of the scaling parameter(s). For instance, according to JVET B0054, a video coding device may derive in-loop scaling parameters for selected transform coefficients (namely, AC coefficients) of the currently-processed block as a function of average values of the luma component in the predicted block, and may derive the DC value for the current block.

According to one or more techniques of this disclosure, video encoder 20 may include one or more DC transform coefficients in the scaling process for currently-coded block 152. In some examples, video encoder 20 may derive the scaling parameters for currently-coded block 152 as a function of a DC value and parameters derived from predicted samples. Video encoder 20 may implement a scaling parameter derivation process that includes a look-up table (LUT) for AC scaling, as well as an independent LUT for DC value(s). Forward scaling of DC and AC transform coefficients results in scaled values denoted as DC′ and AC′. Video encoder 20 may implement scaling operations as described below to obtain the scaled values DC′ and AC′:

AC′=scale(fun1(DC,avgPred))*AC; and

DC′=scale(fun2(DC,avgPred))*DC

In accordance with the scaling parameter-based techniques of this disclosure, video decoder 30 may implement generally reciprocal operations to those described above with respect to video encoder 20. For instance, video decoder 30 may implement an inverse scaling process that uses the scaled values DC′ and AC′ as operands. The results of the inverse scaling process are denoted as DC″ and AC″ in the equations below. Video decoder 30 may implement the inverse scaling operations as illustrated in the following equations:

DC″=DC′/scale(fun1(DC′,avgPred)); and

AC″=AC′/scale(fun2(DC″,avgPred))

With respect to both the scaling and the inverse scaling operations, the terms ‘fun1’ and ‘fun2’ define scale derivation functions/processes that use, as arguments, an average of reference samples and DC-based values. As illustrated with respect to both the scaling and the inverse scaling techniques implemented by video encoder 20 and video decoder 30, the techniques of this disclosure enable the use of DC transform coefficient values in the derivation of both the scaled and inverse-scaled DC and AC transform coefficient values. In this way, techniques of this disclosure enable video encoder 20 and video decoder 30 to leverage DC transform coefficient values in scaling and inverse-scaling operations, if the scaling/inverse-scaling operations are performed in place of quantization and dequantization of transform coefficients.

This disclosure also provides techniques for derivation of quantization parameters or scaling parameters in instances where video encoder 20 does not signal any non-zero transform coefficients. The current specification of HEVC, the initial test model of JVET development, and the design described in JVET B0054 specify derivation of QP values (or scaling parameters, as the case may be) as a function of encoded non-zero transform coefficients that are present. In a case where all transform coefficients are quantized to zero, no QP adjustment nor locally-applied scale are signaled, according to the current specification of HEVC, the initial test model of JVET, and the design of JVET B0054. Instead, the decoding device applies, to the transform coefficients, either a global (e.g., slice level) QP/scaling parameter, or a QP which is derived from spatial neighboring CUs.

Techniques of this disclosure leverage the relative accuracy of prediction (whether intra or inter) which results in the absence of non-zero transform coefficients. For instance, video decoder 30 may implement the techniques of this disclosure to use parameters from predicted samples to derive QP values or scaling parameters. In turn, video decoder 30 may utilize the derived QP values or scaling parameters to dequantize the samples of a current block or to inverse-scale the transform coefficients of the current block. In this way, video decoder 30 may implement techniques of this disclosure to leverage the prediction accuracy in scenarios in which video decoder 30 receives no non-zero transform coefficients for a block, thereby replacing one or more default-based dequantization and inverse-scaling aspects of the HEVC/JEM practices.

Various example implementations of the disclosed techniques are described below. It will be understood that the implementations described below are non-limiting examples, and that other implementations of the disclosed techniques are also possible in accordance with aspects of this disclosure.

According to some implementations, video encoder 20 may derive a reference QP value from attached (top and left) blocks (CUs). Described with respect to FIG. 8, video encoder 20 may derive the reference QP for currently-coded block 152 from data associated with top neighbor block 158 and left neighbor block 156. An example of this example implementation is described by the pseudocode below:

```
Char TComDataCU::getRefQP( UInt uiCurrAbsIdxInCtu )
{
      TComDataCU* cULeft = getQpMinCuLeft ( lPartIdx,
m_absZIdxInCtu + uiCurrAbsIdxInCtu );
      TComDataCU* cUAbove = getQpMinCuAbove( aPartIdx,
m_absZIdxInCtu + uiCurrAbsIdxInCtu );
      return (((cULeft? cULeft->getQP( lPartIdx ):
m_QuLastCodedQP) + (cUAbove? cUAbove->getQP( aPartIdx ):
m_QuLastCodedQP) + 1) >> 1);
}
```

In the pseudocode above, the attached blocks are represented by the symbols “cUAbove” and “cULeft.”

According to some implementations of the techniques of this disclosure, video encoder 20 may take one or more QP values of reference sample(s) into consideration in the QP derivation process. An example of such an implementation is described by the pseudocode below:

```
Char TComDataCU::getRefQP2( UInt uiCurrAbsIdxInCtu )
{
      TComDataCU* cULeft = getQpMinCuLeft ( lPartIdx,
m_absZIdxInCtu + uiCurrAbsIdxInCtu );
      TComDataCU* cUAbove = getQpMinCuAbove( aPartIdx,
m_absZIdxInCtu + uiCurrAbsIdxInCtu );
      TComDataCU* cURefer = getQpMinCuReference( aPartIdx,
m_absZIdxInCtu + uiCurrAbsIdxInCtu );
      return value = function (cULeft->getLastQP( ),
cUAbove->getLastQP( ), cURefer ->getLastQP( ));
}
```

In the pseudocode above, the symbol “cURefer” represents a block that includes reference samples.

According to some implementations of the described techniques, video encoder 20 and/or video decoder 30 may store QPs applied on samples of reference block(s) and/or global QPs (e.g., slice-level QPs) for all pictures utilized as reference pictures. According to some implementations, video encoder 20 and/or video decoder 30 may store scaling parameters applied on samples of reference block(s) and/or global scaling (e.g., slice-level scaling) parameters for all pictures utilized as reference pictures. If a block of reference samples overlaps with multiple CUs of the partitioned block (and thus introducing the possibility of different QPs across the partitions), video encoder 20 may derive the QP from a multitude of the available QPs. As an example, video encoder 20 may implement an averaging process on the multiple QPs from the multiple CUs. An example of such an implementation is described by the pseudocode below:

```
Int sum= 0;
  for (Int i=0; i < numMinPart; i++)
  {
        sum +=
        m_phInferQP[COMPONENT_Y][uiAbsPartIdxInCTU + i];
  }
  avgQP = (sum)/numMinPart;
```

According to the pseudocode above, video encoder 20 performs the averaging processing by calculating a mean value of the QPs across the block partitions. The mean QP calculation is shown in the last operation in the pseudocode above. That is, video encoder 20 divides an aggregate (represented by the final value of the integer “sum”) divided by a count of partitions (represented by the operand “numMinPart”).

In yet another implementation of the techniques described herein, video encoder 20 may derive the QP as a function of the average brightness of luma components. For instance, video encoder 20 may obtain the average brightness of the luma components from a lookup table (LUT). This implementation is described by the following pseudocode, where the symbol “avgPred” represents an average brightness value of the reference samples:

QP=PQ_LUT[avgPred];

In some implementations, video encoder 20 may derive a reference QP value for a current block from one or more global QP values. An example of a global QP value that video encoder 20 may use is a QP specified at the slice level. That is, video encoder 20 may derive the QP value for the current block using a QP value specified for an entirety of a slice that includes the current block. This implementation is described by the following pseudocode:

qp=(((Int)pcCU−>getSlice( )>getSliceQp( )+iDQp+52+2*qpBdOffsetY)%(52+qpBdOffsetY))−qpBdOffsetY;

In the pseudocode above, video encoder 20 uses the value returned by the getSliceQp( ) function as an operand in the operation to obtain the QP for the current block (denoted by “qp”).

In some implementations of the techniques described herein, video encoder 20 may utilize one or more reference sample values in deriving QPs. This implementation is described by the following pseudocode:

QP=PQ_LUT[avgPred];

In the pseudocode above, “PQ_LUT” is a look up table which video encoder 20 may utilize to map an average brightness of the predicted block (represented by “avgPred”) value to an associated perceptual quantizer (PQ) value. Video encoder 20 may compute the value of avgPred as a function of reference samples, such as an average value of the reference samples. Examples of average values that can be used in accordance with the calculations of this disclosure include one or more of mean, median, and mode values.

In some implementations, video encoder 20 may scaling parameters for the current block instead of QPs. In some implementations, video encoder 20 may perform a conversion process from the derived QP(s) to scale parameter(s), or vice versa. In some implementations, video encoder 20 may utilize an analytical expression to derive a QP from reference samples. One example of an analytical expression that video encoder 20 may use for QP derivation is a parametric derivation model.

Regardless of which of the above-described techniques that video encoder 20 derives the QP for the current block, video encoder 20 may signal data based on the derived QP to video decoder 30. For instance, video encoder 20 may signal a delta QP value derived from the QP value that video encoder 20 used to quantize the samples current block. In turn, video decoder 30 may use the delta QP value received in the encoded video bitstream to obtain the QP value for the block, and may dequantize the samples of the block using the QP value.

In examples in which video encoder 20 obtains scaling parameters instead of or in addition to the QP value for the current block, video encoder 20 may signal the scaling parameters (or data derived therefrom) to video decoder 30. In turn, video decoder 30 may reconstruct the scaling parameters, either directly or by deriving the parameters from the signaled data, from the encoded video bitstream. Video decoder 30 may perform inverse scaling of the scaled transform coefficients. For instance, video decoder 30 may perform inverse scaling of scaled versions of both DC and AC transform coefficients, in accordance with aspects of this disclosure.

Various examples (e.g., implementations) have been described above. Examples of this disclosure may be used separately or in various combinations with one or more of the other examples.

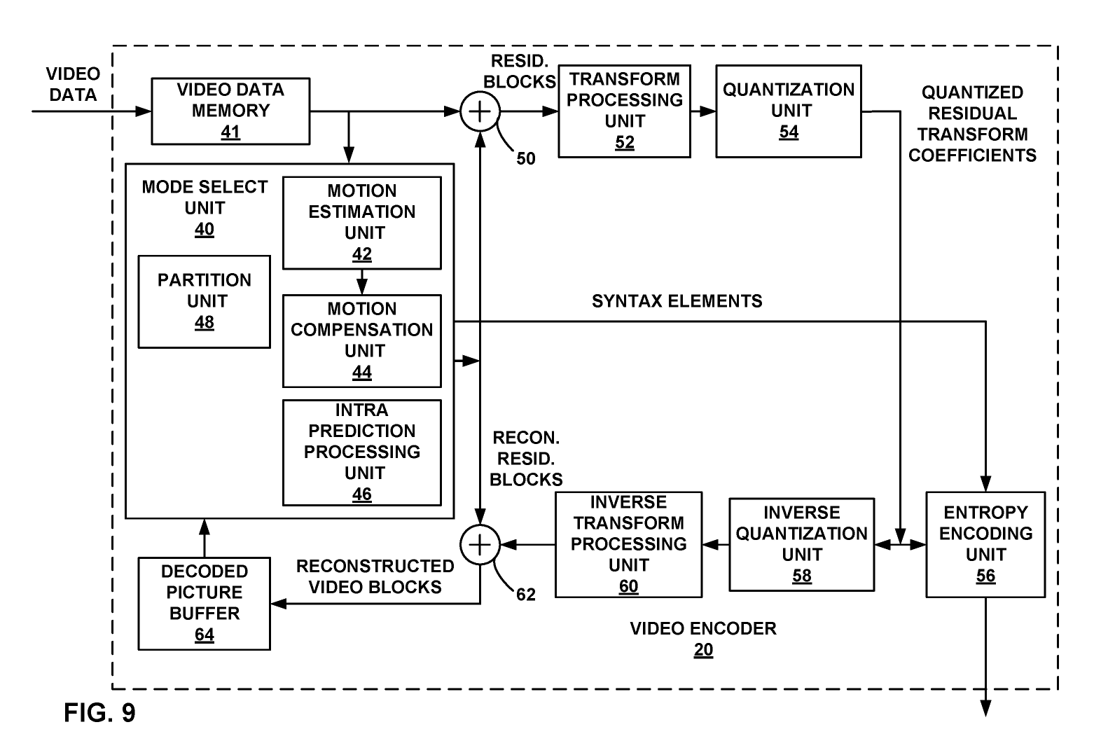

FIG. 9 is a block diagram illustrating an example of video encoder 20 that may implement the techniques of this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 9, video encoder 20 receives a current video block within a video frame to be encoded. In the example of FIG. 9, video encoder 20 includes mode select unit 40, a video data memory 41, a decoded picture buffer 64, a summer 50, a transform processing unit 52, a quantization unit 54, and an entropy encoding unit 56. Mode select unit 40, in turn, includes a motion compensation unit 44, a motion estimation unit 42, an intra prediction processing unit 46, and a partition unit 48. For video block reconstruction, video encoder 20 also includes an inverse quantization unit 58, an inverse transform processing unit 60, and a summer 62. A deblocking filter (not shown in FIG. 9) may also be included to filter block boundaries to remove blockiness artifacts from reconstructed video. If desired, the deblocking filter would typically filter the output of summer 62. Additional filters (e.g., in loop or post loop) may also be used in addition to the deblocking filter. Such filters are not shown for brevity, but if desired, may filter the output of summer 50 (as an in-loop filter).

Video data memory 41 may store video data to be encoded by the components of video encoder 20. The video data stored in video data memory 41 may be obtained, for example, from video source 18. Decoded picture buffer 64 may be a reference picture memory that stores reference video data for use in encoding video data by video encoder 20, e.g., in intra- or inter-coding modes. Video data memory 41 and decoded picture buffer 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 41 and decoded picture buffer 64 may be provided by the same memory device or separate memory devices. In various examples, video data memory 41 may be on-chip with other components of video encoder 20, or off-chip relative to those components.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra prediction processing unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provide the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in decoded picture buffer 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in decoded picture buffer 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra prediction processing unit 46 may intra-predict a current block, as an alternative to the inter-prediction performed by motion estimation unit 42 and motion compensation unit 44, as described above. In particular, intra prediction processing unit 46 may determine an intra-prediction mode to use to encode a current block. In some examples, intra prediction processing unit 46 may encode a current block using various intra-prediction modes, e.g., during separate encoding passes, and intra prediction processing unit 46 (or mode select unit 40, in some examples) may select an appropriate intra-prediction mode to use from the tested modes.

For example, intra prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra prediction processing unit 46 may calculate ratios from the distortions and rates for the various encoded blocks to determine which intra-prediction mode exhibits the best rate-distortion value for the block.

After selecting an intra-prediction mode for a block, intra prediction processing unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54.

Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform processing unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of decoded picture buffer 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in decoded picture buffer 64. The reconstructed video block may be used by motion estimation unit 42 and motion compensation unit 44 as a reference block to inter-code a block in a subsequent video frame.

Video encoder 20 may implement various techniques of this disclosure to derive quantization parameter (QP) values for a currently-encoded block from the block's spatio-temporal neighboring blocks, and/or to apply scaling operations to all (e.g., DC and AC) transform coefficients of the currently-encoded block.

Reference is also made to FIG. 8 in the description below. In some implementations, video encoder 20 may derive a reference QP value for currently-coded block 152 from attached blocks (CUs) of the spatio-temporal neighborhood. That is, video encoder 20 may derive the QP value for currently-coded block 152 using top neighbor block 158 and left neighbor block 156. An example of such an implementation in which video encoder 20 derives the QP value for currently-coded block 152 using top neighbor block 158 and left neighbor block 156 is described by the pseudocode below:

```
Char TComDataCU::getRefQP( UInt uiCurrAbsIdxInCtu )
{
      TComDataCU* cULeft = getQpMinCuLeft ( lPartIdx,
m_absZIdxInCtu + uiCurrAbsIdxInCtu );
      TComDataCU* cUAbove = getQpMinCuAbove( aPartIdx,
m_absZIdxInCtu + uiCurrAbsIdxInCtu );
      return (((cULeft? cULeft->getQP( lPartIdx ):
m_QuLastCodedQP) + (cUAbove? cUAbove->getQP( aPartIdx ):
m_QuLastCodedQP) + 1) >> 1);
}
```

In some implementations, video encoder 20 may derive the QP value for currently-coded block 152 by taking into consideration one or more QP values of reference samples. An example of such an implementation, in which video encoder 20 uses the QP value(s) of the reference samples to derive the QP value for currently-coded block 152 is described by the pseudocode below:

```
Char TComDataCU::getRefQP2( UInt uiCurrAbsIdxInCtu )
{
      TComDataCU* cULeft = getQpMinCuLeft ( lPartIdx,
m_absZIdxInCtu + uiCurrAbsIdxInCtu );
      TComDataCU* cUAbove = getQpMinCuAbove( aPartIdx,
m_absZIdxInCtu + uiCurrAbsIdxInCtu );
      TComDataCU* cURefer = getQpMinCuReference( aPartIdx,
m_absZIdxInCtu + uiCurrAbsIdxInCtu );
      return value = function (cULeft->getLastQP( ),
cUAbove->getLastQP( ), cURefer ->getLastQP( ));
}
```

According to some implementations of the techniques described herein, video encoder 20 may store QPs that are applied to samples of reference block(s) and/or global QPs (e.g., slice-level QPs) for all pictures utilized as reference pictures. According to some implementation of the techniques described herein, video encoder 20 may store the scaling parameters applied to samples of reference block(s) and/or global scaling parameters (e.g., slice-level scaling) for all pictures utilized as reference pictures. If a block of reference samples overlaps with multiple CUs of the block partitioning (thus possibly having different QPs across the partitions), video encoder 20 may derive the QP from a multitude of the available QPs. For example, video encoder 20 may derive the QP for currently-coded block 152 by implementing a process of averaging on the multiple available QPs. An example of an implementation according to which video encoder 20 may derive the QP value for currently-coded block 152 by averaging multiple available QPs from reference samples is described by the pseudocode below:

```
Int sum= 0;
  for (Int i=0; i < numMinPart; i++)
  {
        sum +=
        m_phInferQP[COMPONENT_Y][uiAbsPartIdxInCTU + i];
  }
  avgQP = (sum)/numMinPart;
```

In yet another implementation of the QP-derivation techniques described herein, video encoder 20 may derive the QP as a function of the average brightness of luma components, such as from a lookup table (LUT). This implementation is described by the following pseudocode, where avgPred′ is an average brightness of the reference samples:

QP=PQ_LUT[avgPred];

According to some implementations of the QP-derivation techniques described herein, video encoder 20 may derive a reference QP value from one or more global QP values. An example of a global QP value is a QP value that is specified at the slice level. This implementation is described by the following pseudocode:

qp=(((Int)pcCU−>getSlice( )>getSliceQp( )+iDQp+52+2*qpBdOffsetY)%(52+qpBdOffsetY))−qpBdOffsetY;

According to some implementations of the QP-derivation techniques described herein, video encoder 20 may derive QP values by utilizing one or more reference sample values. This implementation is described by the following pseudocode:

QP=PQ_LUT[avgPred];

In the pseudocode above, “PQ_LUT” represents a look up table which video encoder 20 may utilize to map an average brightness of the predicted block (“avgPred”) value to an associated PQ value. Video encoder 20 may compute the value of avgPred as function of reference samples, such as by computing an average value of the reference samples. Examples of average values that video encoder 20 may use in accordance with the calculations of this disclosure include one or more of mean, median, and mode values.

In some implementations, video encoder 20 may derive scaling parameters instead of QP values. In other implementations, video encoder 20 may use a conversion process that converts derived QP value(s) to scale parameter(s), or vice versa. In some implementations, video encoder 20 may utilize an analytical expression to derive a QP value from one or more reference samples. For instance, to utilize an analytical expression, video encoder 20 may use a parametric derivation model.

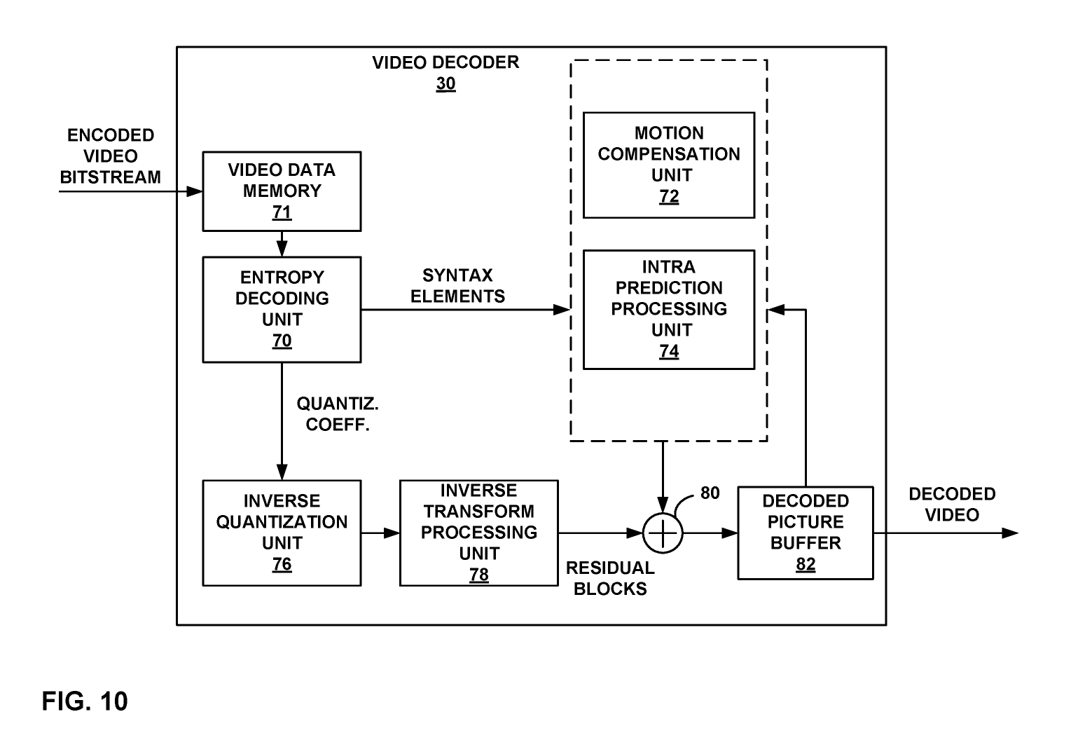

FIG. 10 is a block diagram illustrating an example of video decoder 30 that may implement the techniques of this disclosure. In the example of FIG. 10, video decoder 30 includes an entropy decoding unit 70, a video data memory 71, motion compensation unit 72, intra prediction processing unit 74, inverse quantization unit 76, inverse transform processing unit 78, decoded picture buffer 82 and summer 80. Video decoder 30 may, in some examples, perform a decoding pass generally reciprocal to the encoding pass described with respect to video encoder 20 (FIG. 9). Motion compensation unit 72 may generate prediction data based on motion vectors received from entropy decoding unit 70, while intra prediction processing unit 74 may generate prediction data based on intra-prediction mode indicators received from entropy decoding unit 70.

Video data memory 71 may store video data, such as an encoded video bitstream, to be decoded by the components of video decoder 30. The video data stored in video data memory 71 may be obtained, for example, from computer-readable medium 16, e.g., from a local video source, such as a camera, via wired or wireless network communication of video data, or by accessing physical data storage media. Video data memory 71 may form a coded picture buffer (CPB) that stores encoded video data from an encoded video bitstream. Decoded picture buffer 82 may be a reference picture memory that stores reference video data for use in decoding video data by video decoder 30, e.g., in intra- or inter-coding modes. Video data memory 71 and decoded picture buffer 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 71 and decoded picture buffer 82 may be provided by the same memory device or separate memory devices. In various examples, video data memory 71 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction processing unit 74 may generate prediction data for a video block of the current video slice based on a signaled intra prediction mode and data from previously decoded blocks of the current frame or picture. When the video frame is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in decoded picture buffer 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform processing unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform processing unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in decoded picture buffer 82, which stores reference pictures used for subsequent motion compensation. Decoded picture buffer 82 also stores decoded video for later presentation on a display device, such as display device 32 of FIG. 1.

Video decoder 30 may receive, in an encoded video bitstream, a delta QP value that is derived from the QP value obtained by video encoder 20 according to one or more of the techniques described above. Using the delta QP value, video decoder 30 may obtain the QP value pertaining to a block that is currently being decoded, such as currently-coded block 152 illustrated in FIG. 8. In turn, video decoder 30 may dequantize currently-coded block 152 using the QP value.

In instances where video decoder 30 receives scaling parameters for currently-coded block 152, video decoder 30 may use the scaling parameters to implement an inverse scaling process that is generally reciprocal to various that uses the scaled values DC′ and AC′ as operands. That is, video decoder 30 may apply the scaling parameters to inverse-scale the scaled DC transform coefficients DC′ and the scaled AC transform coefficients AC′ to obtain inverse-scaled DC coefficients DC″ and inverse-scaled AC transform coefficients AC″ as expressed by the equations below. Video decoder 30 may implement the inverse scaling operations as illustrated in the following equations:

DC″=DC′/scale(fun1(DC′,avgPred)); and

AC″=AC′/scale(fun2(DC″,avgPred))

The terms ‘fun1’ and ‘fun2’ define scale derivation functions/processes that use, as arguments, an average of reference samples and DC-based values. As illustrated with respect to the inverse-scaling techniques implemented by video decoder 30, the techniques of this disclosure enable the use of DC transform coefficient values in the derivation of both the DC and AC transform coefficient values. In this way, techniques of this disclosure enable video decoder 30 to leverage DC transform coefficient values in inverse-scaling operations, regardless of whether the inverse-scaling operations are performed in place of, or in combination with, quantization and dequantization of transform coefficients.

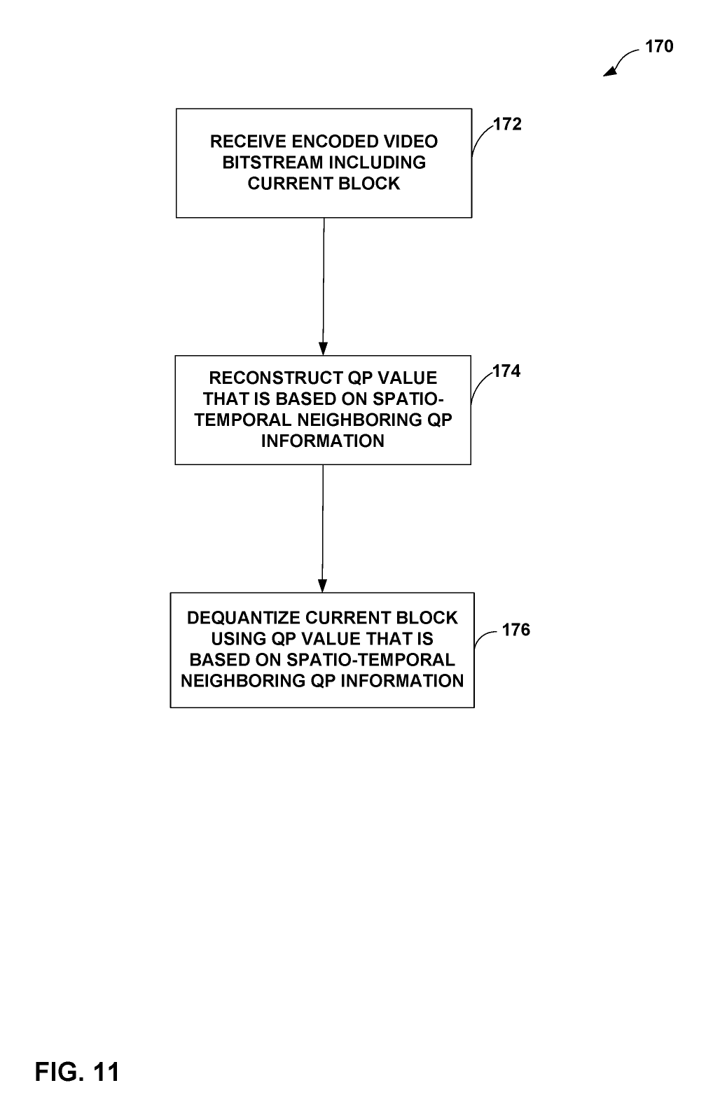

FIG. 11 is a flowchart illustrating an example process 170 that video decoder 30 may perform, according to various aspects of this disclosure. Process 170 may begin when video decoder 30 receives an encoded video bitstream that includes an encoded representation of current block 152 (172). Video decoder 30 may reconstruct a QP value that is based on the spatio-temporal neighboring QP information for current block 152 (174). For instance, video decoder 30 may reconstruct the QP from a delta QP value signaled in the encoded video bitstream. The reconstructed QP value may be based on QP information from one or more of blocks 154-158 illustrated in FIG. 8. As discussed above, to reconstruct the QP value, video decoder 30 may average QP values of two or more of the spatio-temporal neighboring blocks 154-158 to produce a reference QP value, then add the delta QP value to the reference QP value to ultimately generate the reconstructed QP value for the current block. In turn, video decoder 30 (and more particularly, inverse quantization unit 76) may dequantize (i.e., inverse-quantize) CABAC-decoded transform coefficients of current block 152 using the reconstructed QP value that is based on the spatio-temporal neighboring QP information (176). In some examples, video decoder 30 may obtain a reference QP value for samples of current block 152 based on samples of the spatio-temporal neighborhood, and may add the delta QP value to the reference QP value to derive the QP value for dequantizing the samples of current block 152.

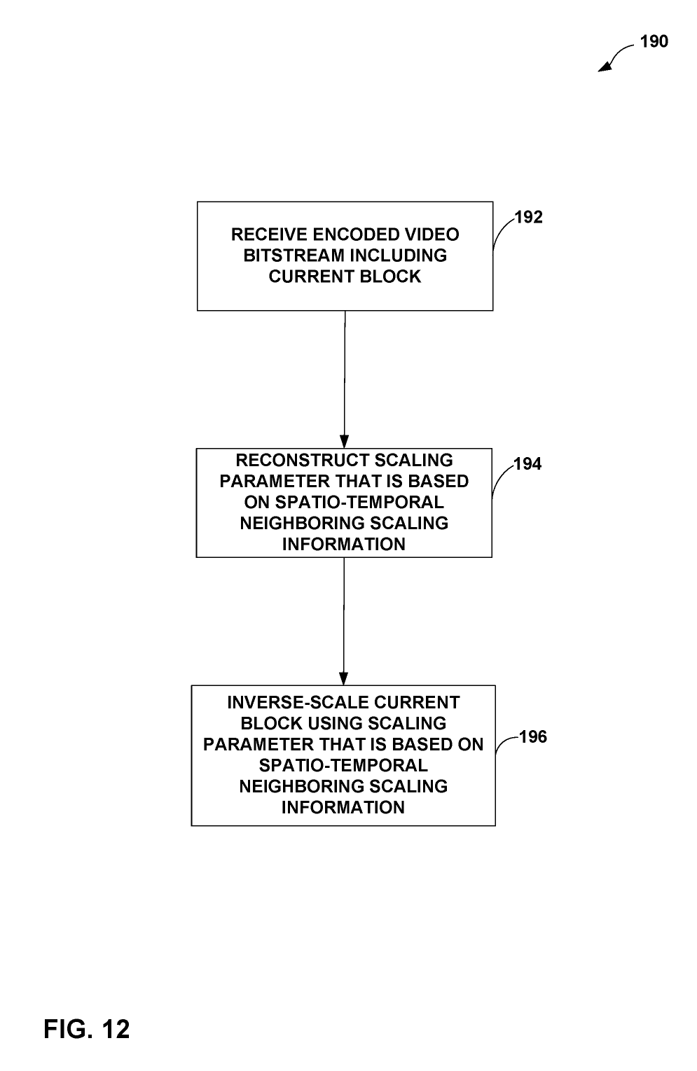

FIG. 12 is a flowchart illustrating an example process 190 that video decoder 30 may perform, according to various aspects of this disclosure. Process 190 may begin when video decoder 30 receives an encoded video bitstream that includes an encoded representation of current block 152 (192). Video decoder 30 may reconstruct a scaling parameter that is based on the spatio-temporal neighboring scaling information for current block 152 (194). For instance, the reconstructed scaling parameter may be based on scaling information from one or more of blocks 154-158 illustrated in FIG. 8. In turn, video decoder 30 may inverse scale current block 152 using the reconstructed scaling parameter that is based on the spatio-temporal neighboring QP information (196). In some examples, video decoder 30 may apply a first inverse scaling derivation process to a plurality of DC transform coefficients of the transform coefficients of current block 152 to obtain a plurality of inverse-scaled DC transform coefficients, and may apply a second inverse scaling derivation process to the plurality of inverse-scaled DC transform coefficients of the transform coefficients of current block 152 to obtain a plurality of inverse-scaled AC transform coefficients.

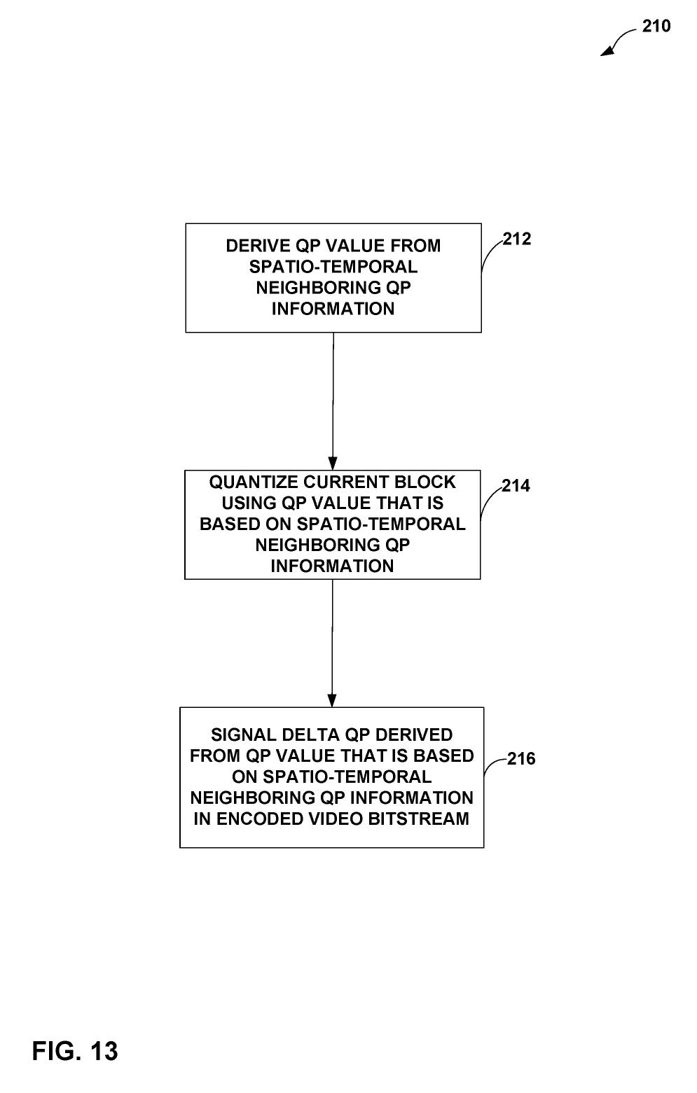

FIG. 13 is a flowchart illustrating an example process 210 that video encoder 20 may perform, according to various aspects of this disclosure. Process 210 may begin when video encoder 20 derives a QP value for current block 152 from spatio-temporal neighboring QP information of current block 152 (212). Video encoder 20 may quantize current block 152 using the QP value derived from the spatio-temporal neighboring QP information (214). In turn, video encoder 20 may signal a delta QP value that derived from the QP that is based on the spatio-temporal neighboring QP information in an encoded video bitstream (216). In some examples, video encoder 20 may select neighbor QP values associated with samples of two or more of the spatial neighbor blocks 154 and/or 156 and/or temporal neighbor block 158. In some examples, video encoder 20 may average the selected neighbor QP values to obtain an average QP value, and may derive the QP value for the current block from the average QP value. In some examples, video encoder 20 may obtain a reference QP value for samples of current block 152 based on samples of the spatio-temporal neighborhood. In these examples, video encoder 20 may subtract the reference QP value from the QP value to derive a delta quantization parameter (QP) value for the samples of current block 152, and may signal the delta QP value in an encoded video bitstream.

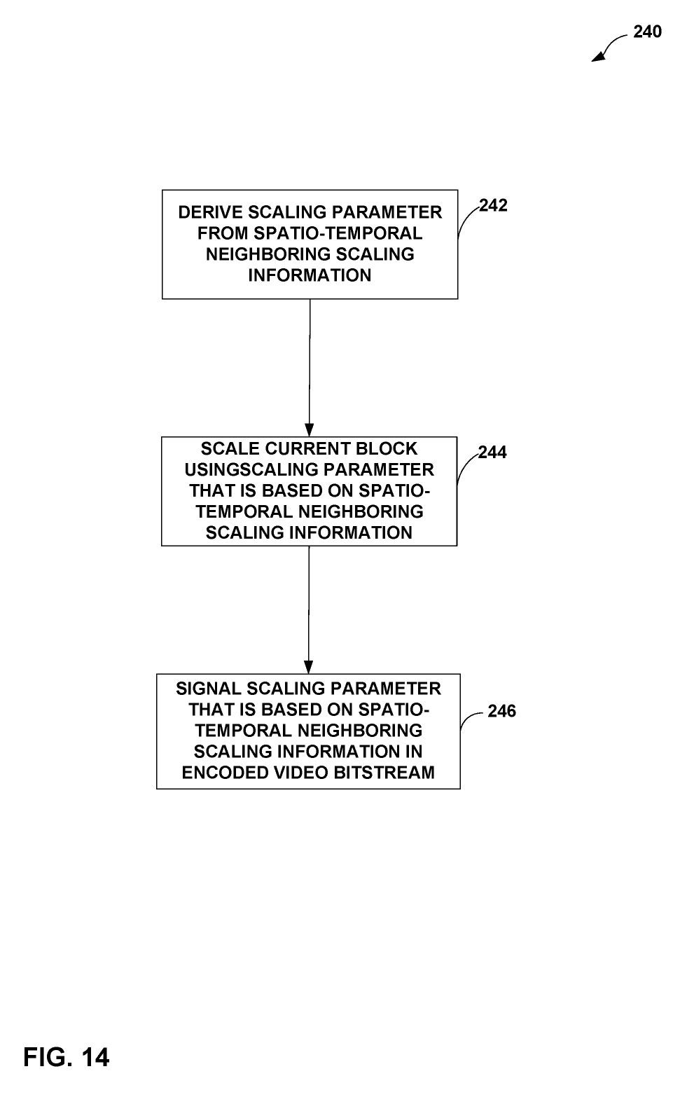

FIG. 14 is a flowchart illustrating an example process 240 that video encoder 20 may perform, according to various aspects of this disclosure. Process 240 may begin when video encoder 20 derives a scaling parameter for current block 152 from spatio-temporal neighboring scaling information of current block 152 (242). Video encoder 20 may scale current block 152 using the scaling parameter derived from the spatio-temporal neighboring scaling information (244). In turn, video encoder 20 may signal the scaling parameter that is based on the spatio-temporal neighboring scaling information in an encoded video bitstream (246).

As described above, the disclosed systems and techniques also incorporate or include several algorithms for derivation of quantization or scaling parameters from a spatio-temporal neighborhood of the signal. That is, example systems and techniques of this disclosure are directed to obtaining one or more parameter values that are used to modify residual data associated with the current block in a coding process. As used herein, a parameter value that is used to modify residual data may include a quantization parameter (used to modify the residual data by quantizing or dequantizing residual data in an encoding process or decoding process, respectively), or a scaling parameter (used to modify the residual data by scaling or inverse-scaling residual data in an encoding process or decoding process, respectively).

Certain aspects of this disclosure have been described with respect to extensions of the HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding a current block of video data, the method comprising:
obtaining a parameter value that is based on one or more corresponding parameter values associated with one or more neighbor blocks of the video data positioned within a spatio-temporal neighborhood of the current block, wherein the spatio-temporal neighborhood includes one or more spatial neighbor blocks that are positioned adjacent to the current block and a temporal neighbor block that is pointed to by a disparity vector (DV) associated with the current block, and wherein the obtained parameter value is used to modify residual data associated with the current block in a coding process; and
coding the current block of the video data based on the obtained parameter value.

2. The method of claim 1, wherein the obtained parameter value comprises a quantization parameter (QP) value, and wherein coding the current block based on the obtained parameter value comprises decoding the current block at least in part by dequantizing samples of the current block using the QP value.

3. The method of claim 2, wherein obtaining the QP value comprises:
receiving, in an encoded video bitstream, a delta quantization parameter (QP) value;
obtaining a reference QP value for samples of the current block based on samples of the spatio-temporal neighborhood; and
adding the delta QP value to the reference QP value to derive the QP value for dequantizing the samples of the current block.

4. The method of claim 1, wherein the obtained parameter value comprises a scaling parameter value, and wherein coding the current block based on the obtained parameter value comprises decoding the current block at least in part by inverse scaling transform coefficients of the current block using the scaling parameter value.

5. The method of claim 4, wherein inverse scaling the transform coefficients of the current block comprises:
applying a first inverse scaling derivation process to a plurality of DC transform coefficients of the transform coefficients of the current block to obtain a plurality of inverse-scaled DC transform coefficients; and
applying a second inverse scaling derivation process to the plurality of inverse-scaled DC transform coefficients of the transform coefficients of the current block to obtain a plurality of inverse-scaled AC transform coefficients.

6. The method of claim 1, wherein obtaining the parameter value comprises obtaining a quantization parameter (QP) value, comprising:
selecting neighbor QP values associated with samples of two or more of the spatial neighbor blocks or the temporal neighbor block;
averaging the selected neighbor QP values to obtain an average QP value; and
deriving the QP value for the current block from the average QP value,
wherein coding the current block based on the obtained parameter value comprises encoding the current block at least in part by quantizing the current block using the QP value.

7. The method of claim 6, further comprising:
obtaining a reference QP value for samples of the current block based on samples of the spatio-temporal neighborhood;
subtracting the reference QP value from the QP value to derive a delta quantization parameter (QP) value for the samples of the current block; and
signaling, in an encoded video bitstream, the delta QP value.

8. The method of claim 1, wherein the obtained parameter value comprises a scaling parameter value, and wherein coding the current block based on the obtained parameter value comprises encoding the current block at least in part by scaling transform coefficients of the current block using the scaling parameter value.

9. The method of claim 8, wherein scaling the transform coefficients of the current block comprises:
applying a first scaling derivation process to a plurality of DC transform coefficients of the transform coefficients of the current block; and
applying a second scaling derivation process to a plurality of DC transform coefficients of the transform coefficients of the current block.

10. The method of claim 1, wherein the obtained parameter value comprises a global parameter value that is applicable to all blocks of a slice that includes the current block.

11. A device for coding video data, the device comprising:
a memory configured to store video data including a current block; and
processing circuitry in communication with the memory, the processing circuitry being configured to:
obtain a parameter value that is based on one or more corresponding parameter values associated with one or more neighbor blocks of the video data stored to the memory, the one or more neighbor blocks being positioned within a spatio-temporal neighborhood of the current block, wherein the spatio-temporal neighborhood includes one or more spatial neighbor blocks that are positioned adjacent to the current block and a temporal neighbor block that is pointed to by a disparity vector (DV) associated with the current block, and wherein the obtained parameter value is used to modify residual data associated with the current block in a coding process; and
code the current block of the video data stored to the memory.

12. The device of claim 11, wherein the obtained parameter value comprises a quantization parameter (QP) value, and wherein to code the current block based on the obtained parameter value, the processing circuitry is configured to decode the current block at least in part by dequantizing samples of the current block using the QP value.

13. The device of claim 12, wherein to obtain the QP value, the processing circuitry is configured to:
receive, in an encoded video bitstream, a delta quantization parameter (QP) value;
obtain a reference QP value for samples of the current block based on samples of the spatio-temporal neighborhood; and
add the delta QP value to the reference QP value to derive the QP value for dequantizing the samples of the current block.

14. The device of claim 11, wherein the obtained parameter value comprises a scaling parameter value, and wherein to code the current block based on the obtained parameter value, the processing circuitry is configured to decode the current block at least in part by inverse scaling transform coefficients of the current block using the scaling parameter value.

15. The device of claim 14, wherein to inverse scale the transform coefficients of the current block, the processing circuitry is configured to:
apply a first inverse scaling derivation process to a plurality of DC transform coefficients of the transform coefficients of the current block to obtain a plurality of inverse-scaled DC transform coefficients; and
apply a second inverse scaling derivation process to the plurality of inverse-scaled DC transform coefficients of the transform coefficients of the current block to obtain a plurality of inverse-scaled AC transform coefficients.

16. The device of claim 11,
wherein the parameter value comprises a quantization parameter (QP) value,
wherein to obtain the QP value, the processing circuitry is configured to:
select neighbor QP values associated with samples of two or more of the spatial neighbor blocks or the temporal neighbor block;
average the selected neighbor QP values to obtain an average QP value; and
derive the QP value for the current block from the average QP value, and
wherein to code the current block based on the obtained parameter value, the processing circuitry is configured to encode the current block at least in part by quantizing the current block using the QP value.

17. The device of claim 16, wherein the processing circuitry is further configured to:
obtain a reference QP value for samples of the current block based on samples of the spatio-temporal neighborhood;
subtract the reference QP value from the QP value to derive a delta quantization parameter (QP) value for the samples of the current block; and
signal, in an encoded video bitstream, the delta QP value.

18. The device of claim 11, wherein the obtained parameter value comprises a scaling parameter value, and wherein to code the current block based on the obtained parameter value, the processing circuitry is configured to encode the current block at least in part by scaling transform coefficients of the current block using the scaling parameter value.

19. The device of claim 18, wherein to scale the transform coefficients of the current block, the processing circuitry is configured to:
apply a first scaling derivation process to a plurality of DC transform coefficients of the transform coefficients of the current block; and
apply a second scaling derivation process to a plurality of DC transform coefficients of the transform coefficients of the current block.

20. The device of claim 11, wherein the obtained parameter value comprises a global parameter value that is applicable to all blocks of a slice that includes the current block.

21. An apparatus for coding video data, the apparatus comprising:
means for obtaining a parameter value that is based on one or more corresponding parameter values associated with one or more neighbor blocks of the video data positioned within a spatio-temporal neighborhood of a current block of the video data, wherein the spatio-temporal neighborhood includes one or more spatial neighbor blocks that are positioned adjacent to the current block and a temporal neighbor block that is pointed to by a disparity vector (DV) associated with the current block, and wherein the obtained parameter value is used to modify residual data associated with the current block in a coding process; and
means for coding the current block of the video data based on the obtained parameter value.

22. A non-transitory computer-readable storage medium encoded with instructions that, when executed, cause processing circuitry of a video coding device to:
obtain a parameter value that is based on one or more corresponding parameter values associated with one or more neighbor blocks of the video data positioned within a spatio-temporal neighborhood of a current block of the video data, wherein the spatio-temporal neighborhood includes one or more spatial neighbor blocks that are positioned adjacent to the current block and a temporal neighbor block that is pointed to by a disparity vector (DV) associated with the current block, and wherein the obtained parameter value is used to modify residual data associated with the current block in a coding process; and
code the current block of the video data based on the obtained parameter value.
